(19) United States
(12) Patent Application Publication
(10) Pub. No.: US 2012/0045114 A1
(43) Pub. Date: Feb. 23, 2012

(54) Authentication device, authentication method, and an information storage medium storing a program

(75) Inventors: Yasuhiro Matsumaru, Kanagawa (JP); Kenta Ogawa, Kanagawa (JP)

(73) Assignee: Renesas Electronics Corporation, Kawasaki-shi (JP)

(21) Appl. No.: 13/137,288

(22) Filed: Aug. 3, 2011

(30) Foreign Application Priority Data
Aug. 18, 2010 (JP) 2010-183374

(51) Int. Cl. G06K 9/62

(52) U.S. Cl. 382/145

(57) ABSTRACT

There is provided an authentication device including an authentication information storage unit that stores authentication information acquired from an authentication pattern including a part or the entirety of a mottled pattern or a dot pattern formed over an electronic component as information for indentifying each of a plurality of electronic components, an authentication information acquiring unit that acquires a first authentication information acquired from the authentication pattern formed over a first electronic component that is an object to be authenticated, a search unit that searches whether or not the authentication information storage unit stores the first authentication information by using the first authentication information as a search key, and an output unit that outputs a search result of the search unit.

This application is based on Japanese patent application No. 2010-183374, the content of which is incorporated hereinto by reference.

### BACKGROUND

1. Technical Field

The invention relates to an authentication device, an authentication method, and an information storage medium storing a program.

2. Related Art

As individual authentication technologies for confirming the traceability of an electronic component such as a semiconductor device, and whether or not the electronic component is genuine, for example, a technology described in Japanese Laid-Open Patent Publication No. 2007-242973 may be exemplified.

Japanese Laid-Open Patent Publication No. 2007-242973 discloses a technology in which a mottled pattern is formed on a sealing surface formed of a sealing resin and the mottled pattern is used as an authentication pattern, as an individual authentication technology of a semiconductor device having a structure in which a semiconductor chip is sealed with a sealing resin.

Specifically, the mottled pattern formed for each semiconductor device is imaged, respectively, and this still image data is correlated with identification data (product code or production number) of each semiconductor device and is registered in a database server. In addition, this identification data (product code or production number) is marked on a surface of the semiconductor.

At the time of the authentication processing, first, the authentication device acquires the still image data of the mottled pattern formed on the surface of the semiconductor device that is an authentication object. Next, when receiving an input from a user, the authentication device acquires the identification data (product code or production number) marked on the surface of the semiconductor. Then, the authentication device searches the database server using the acquired identification data (product code or production number) as a service key, and fetches the still image data correlated with the identification data. Subsequently, the fetched still image data and the still image data of the semiconductor device that is an authentication object are compared using pattern matching or the like, and when they are matched with each other, it is determined that the semiconductor device is “genuine”.

### SUMMARY

In the case of the technology disclosed in Japanese Laid-Open Patent Publication No. 2007-242973, it is necessary that the user reads out the identification data marked on the surface of the semiconductor device, and inputs the data in a computer, and accordingly, this is time-consuming work. Particularly, when the technology disclosed in Japanese Laid-Open Patent Publication No. 2007-242973 is applied to a small-sized electronic component, a region where the identification data is marked is narrow in the small-sized electronic component, such that the identification data is marked in a narrow pitch with a small-sized character, and the readout of such an identification data is extremely time-consuming work.

In an embodiment, there is provided an authentication device including an authentication information storage unit that stores authentication information acquired from an authentication pattern including a part or the entirety of a mottled pattern or a dot pattern formed over an electronic component as information for indentifying each of a plurality of electronic components, an authentication information acquiring unit that acquires first authentication information acquired from the authentication pattern formed over a first electronic component that is an object to be authenticated, a search unit that searches whether or not the authentication information storage unit stores the first authentication information by using the first authentication information as a search key, and an output unit that outputs a search result of the search unit.

In another embodiment, there is provided an authentication method, in which authentication information acquired from an authentication pattern including a part or the entirety of a mottled pattern or a dot pattern formed over an electronic component is stored in a memory in advance as information for indentifying each of a plurality of electronic components. The method includes acquiring a first authentication information from the authentication pattern formed over a first electronic component that is an object to be authenticated, searching whether or not the first authentication information is stored in the memory, and outputting a search result of the step of searching.

In still another embodiment, there is provided an information storage medium storing a program for performing an authentication of an electronic component by using a database in which authentication information acquired from an authentication pattern including a part or the entirety of a mottled pattern or a dot pattern formed over the electronic component is stored in advance as information for indentifying each of a plurality of electronic components. The program allows a computer to perform acquiring a first authentication information from the authentication pattern formed over a first electronic component that is an object to be authenticated, searching whether or not the first authentication information is stored in the database, and outputting a search result of the step of searching.

According to the above-described embodiments, a user, who desires to confirm whether or not an electronic component possessed by the user is genuine, only needs to image an authentication pattern including a mottled pattern or a dot pattern formed over the electronic component, and to input the still image data to the authentication device. That is, it is not necessary to read out information including characters, numbers, or the like marked on the electronic component. As described above, according to the embodiments of the invention, it is possible to perform an individual authentication of the electronic component with sufficient accuracy without burdening a user with laborious work.

According to the embodiments of the invention, it is possible to perform an individual authentication of the electronic component with sufficient accuracy without burdening a user with laborious work.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 represents a diagram schematically illustrating an example of an authentication pattern of an embodiment;

FIG. 2 represents a diagram schematically illustrating an example of an authentication pattern of the embodiment;

FIG. 3 represents a functional block diagram illustrating an example of a configuration of the authentication device of the embodiment;

FIG. 4 represents a flow chart illustrating an example of a processing flow of an authentication method of the embodiment;

FIG. 5 represents a flow chart illustrating an example of a processing flow of the authentication method of the embodiment;

FIG. 6 represents a functional block diagram illustrating an example of a configuration of the authentication device of the embodiment;

FIG. 7 represents a functional block diagram illustrating an example of a configuration of the authentication device of the embodiment;

FIGS. 8A and 8B represent diagrams schematically illustrating an example of a configuration of an electronic component of the embodiment;

FIG. 9 represents a flow chart illustrating an example of a method of manufacturing the electronic component of the embodiment;

FIG. 10 represents a diagram schematically illustrating an example of the electronic component of the embodiment;

FIGS. 11A and 11B represent diagrams schematically illustrating an example of the electronic component of the embodiment;

FIG. 12 represents a diagram schematically illustrating an example of the electronic component of the embodiment;

FIG. 13 represents a diagram schematically illustrating an example of the electronic component of the embodiment;

FIG. 14 represents a diagram schematically illustrating an example of the electronic component of the embodiment;

FIG. 15 represents a diagram schematically illustrating an example of the electronic component of the embodiment;

FIG. 16 represents a flow chart illustrating an example of the method of manufacturing the electronic component of the embodiment;

FIG. 17 represents a diagram schematically illustrating an example of the electronic component of the embodiment;

FIG. 18 represents a diagram schematically illustrating an example of the electronic component of the embodiment;

FIG. 19 represents a diagram schematically illustrating an example of the electronic component of the embodiment;

FIG. 20 represents a functional block diagram illustrating an example of a configuration of the authentication device of the embodiment;

FIG. 21 represents a flow chart illustrating an example of a processing flow of the authentication device of the embodiment;

FIG. 22 represents a functional block diagram illustrating an example of a configuration of the authentication device of the embodiment; and

FIG. 23 represents a functional block diagram illustrating an example of a configuration of the authentication device of the embodiment.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Hereinafter, embodiments of the invention will be described with reference to the accompanying drawings.

In addition, each of parts making up an authentication device of the embodiments may be realized by an arbitrary composition of hardware and software, which mainly includes a CPU, a memory, a program (including a program downloaded from a recording medium such as a CD or the like, or a server over the internet, in addition to a program stored in the memory from a step of shipping the device) downloaded to the memory, a storage unit such as a hard disk that stores the program, and an interface for a network connection of an arbitrary computer. Those skilled in the art will recognize that various modifications of the realization method and the device may be made.

In addition, functional block diagrams used for the description of the embodiments do not illustrate a hardware unit configuration but a block of a functional unit. In these drawings, it is described that the authentication device of the embodiment is realized by one device, but the configuration for the realization is not limited thereto. That is, a physically dividable configuration or a logically dividable configuration may be possible.

### First Embodiment

Authentication Device 1

First, an outline of the authentication device 1 of this embodiment will be described.

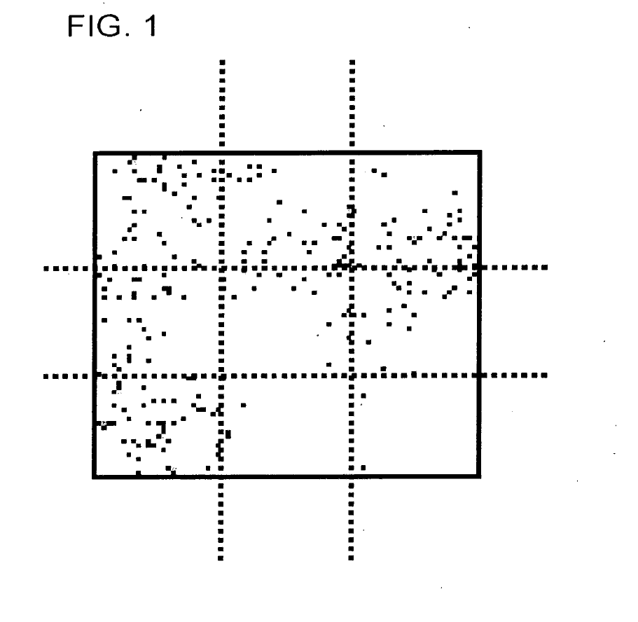

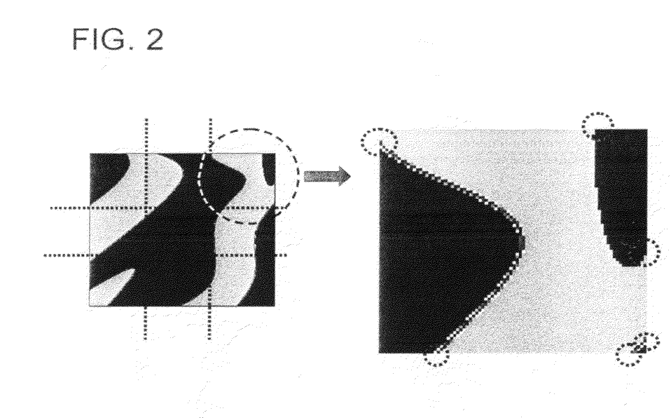

The authentication device 1 of this embodiment uses a part or the entirety of a mottled pattern or a dot pattern formed on an electronic component as an authentication pattern. That is, the pattern is used for identifying each electronic component. For reference, FIG. 1 illustrates an example of the dot pattern, and FIG. 2 illustrates an example of the mottled pattern.

When acquiring still image data of the authentication pattern formed on each electronic component, the authentication device 1 encodes the authentication pattern according to a predetermined encoding rule. The information after the encoding is stored as authentication information of the electronic component. In addition, attribute information of the electronic component may be stored with the attribute information correlated with the authentication information. The attribute information may include a product name of the electronic component, a lot number, facility type and number used for manufacturing the electronic component, a work date and time and a worker's name in each process for manufacturing and inspecting the electronic component, manufacturing conditions, yield-related information, experimental data of the electronic component, defect inspection data, or the like. In addition, the exemplification of the attribute information is illustrative only, and other information may be included and one or more types of the information may be included.

When acquiring still image data of the authentication pattern formed on the electronic component that is an object to be authenticated as genuine or not, the authentication device 1 encodes the authentication pattern according to a predetermined encoding rule and confirms whether or not the information after the encoding is stored. As a result of the confirmation, in a case where the information is stored, the authentication device 1 outputs information indicating this. In addition, if necessary, the attribute information correlated with the information after the encoding is output. As a result, a user can determine whether or not the electronic component is genuine. On the other hand, as a result of the confirmation, in a case where the information is not stored, the authentication device 1 outputs information indicating this. As a result, the user can determine whether or not the electronic component is genuine.

Hereinafter, a configuration of the authentication device 1 of this embodiment will be described in detail.

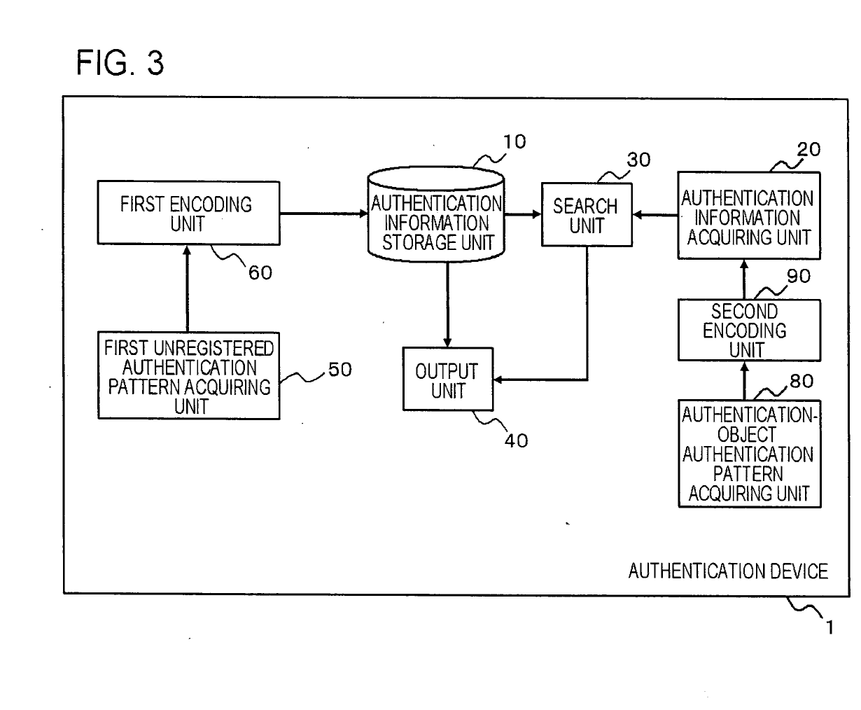

As shown in FIG. 3, the authentication device 1 of this embodiment includes an authentication information storage unit 10, an authentication information acquiring unit 20, a search unit 30, and an output unit 40. The authentication device 1 of this embodiment may further include a first unregistered authentication pattern acquiring unit 50, and a first encoding unit 60. In addition, the authentication device 1 may further include an authentication-object authentication pattern acquiring unit 80 and a second encoding unit 90.

The authentication information storage unit 10 stores the authentication information acquired from the authentication pattern as information for identifying each of a plurality of electronic components. The authentication pattern includes a part or the entirety of the mottled pattern or the dot pattern formed on the electronic component. For reference, FIG. 1 illustrates an example of the dot pattern, and FIG. 2 illustrates an example of the mottled pattern. Such a pattern is formed on the electronic component of this embodiment, and the authentication pattern 1 of this embodiment uses a part or the entirety of the pattern formed on the electronic component as the authentication pattern. In addition, a unit that forms such a pattern on the electronic component is not particularly limited, but an example thereof will be described later.

Here, the authentication information storage unit 10 stores information after encoding the authentication pattern according to a predetermined encoding rule as authentication information acquired from the authentication pattern, that is, as information for identifying each electronic component. The generation of such authentication information is realized by the first unregistered authentication pattern acquiring unit 50 and the first encoding unit 60.

The first unregistered authentication pattern acquiring unit 50 acquires still image data of an authentication pattern formed on an electronic component (hereinafter, referred to as a second electronic component) whose authentication information is not stored in the authentication information storage unit 10. In addition, a timing for imaging the authentication pattern formed on the second electronic component is not particularly limited, but may be a timing described below. For example, as one process among processes for manufacturing the electronic component, a process of imaging the authentication pattern formed on the second electronic component is included, and the imaging of the pattern may be performed at this timing. The imaging at the timing may be performed, for example, by the manufacturer of the electronic component. In addition, the authentication pattern formed on the second electronic component may be imaged at a timing not included during the process of manufacturing the electronic component. The imaging at the timing may be performed, for example, by the manufacturer of the electronic component, or an authenticator (a person whose job is to authenticate the electronic component) different from the manufacturer of the electronic component.

In addition, a case of including an image other than the authentication pattern in the still image data may be considered, in which the first unregistered authentication pattern acquiring unit 50 may be configured in a manner that can specify the authentication pattern included in the still image data. The details of the configuration are not particularly restricted, but for example, it may be a configuration described below.

First, a piece of information (for example, a cross mark that includes an upward arrow attached at the center of the authentication pattern, and hereinafter, referred to as “specific information”) for specifying the authentication pattern is attached on the electronic component. The process of attaching the specific information to the electronic component may be included as one process among the processes of manufacturing the electronic component. The first unregistered authentication pattern acquiring unit 50 specifies the authentication pattern using the specific information. For example, the first unregistered authentication pattern acquiring unit 50 recognizes the specific information attached on the electronic component in advance, and searches for and specifies the specific information in the still image data. When the specific information is specified in the still image data, the first unregistered authentication pattern acquiring unit 50 specifies a predetermined direction of the still image data using the information (for example, a direction indicated by the upward arrow is set to “upward direction”). In addition, a scale reduction is calculated (for example, calculated by comparing the size of the cross mark in the still image data, and the size of the cross mark actually attached to the electronic component), and by using this information and a location at which the specific information is attached, the authentication pattern occupying a predetermined region in the still image data may be specified. In addition, the above-described configuration is illustrative only, and the first unregistered authentication pattern acquiring unit 50 may specify the authentication pattern in the still image data by using another configuration.

The first encoding unit 60 encodes the authentication pattern according to a predetermined encoding rule by using the still image data acquired by the first unregistered authentication pattern acquiring unit 50.

The encoding rule is not particularly limited, however, for example, it may be a rule in which plural pieces of information that can be acquired from a dot pattern (authentication pattern), for example, the number of dots in a case where the authentication pattern is a dot pattern, the number of dots for each color in a case where dots of a plurality of colors are present, a positional relationship of a plurality of dots (for example, information in which a plurality vectors are collected, each indicating a positional relationship of two dots), or the like are set as input information, and a result of calculation based on a predetermined algorithm is set as one output information (information after the encoding). In addition, in a case where the authentication pattern is a mottled pattern, the encoding rule may be a rule in which plural pieces of information that can be acquired from the mottled pattern (authentication pattern), for example, coordinate information of a color boundary portion (a boundary portion of the mottled pattern) on an outer frame of the authentication pattern, an area occupancy of each color, a color at the central position of the authentication pattern, or the like are set as input information, and a result of calculation based on a predetermined algorithm is set as a piece of output information (information after the encoding). In addition, the above-described encoding rule is illustrative only, and the encoding rule of this embodiment is not limited to such a rule.

The authentication information storage unit 10 stores authentication information generated by the first unregistered authentication pattern acquiring unit 50 and the first encoding unit 60, that is, information after encoding the authentication pattern according to a predetermined encoding rule as information for identifying each electronic component. In addition, the authentication information storage unit 10 may store the authentication information with attribute information of each electronic component correlated with the authentication information. The attribute information of the electronic component is the same as that described above, and therefore the description thereof will not be repeated.

The authentication information acquiring unit 20 acquires authentication information (hereinafter, referred to as a first authentication information) acquired from the authentication pattern formed on an electronic component (hereinafter, referred to as a first electronic component) that is an object to be authenticated.

Here, the authentication information acquiring unit 20 acquires information after encoding the authentication pattern formed on the first electronic component according to a predetermined encoding rule as first authentication information. The generation of such first authentication information is realized by the authentication-object authentication pattern acquiring unit 80 and the second encoding unit 90.

The authentication-object authentication pattern acquiring unit 80 acquires still image data of the authentication pattern of the first electronic component. For example, this acquisition may be realized by receiving an input of such still image data from a user.

In addition, a case of including an image other than the authentication pattern in the still image data may be considered, in which the authentication-object authentication pattern acquiring unit 80 may be configured in a manner that can specify the authentication pattern included in the still image data. Such a configuration is not particularly restricted, but for example, may use the same configuration as that described in regard to the first unregistered authentication pattern acquiring unit 50.

The second encoding unit 90 encodes the authentication pattern according to a predetermined encoding rule by using the still image data acquired by the authentication-object authentication pattern acquiring unit-80. In addition, the encoding rule used by the second encoding unit 90 is the same as that used by the first encoding unit 60.

The authentication information acquiring unit 20 acquires information after the encoding, which is generated by the authentication-object authentication pattern acquiring unit 80 and the second encoding unit 90, as the first authentication information.

The search unit 30 searches whether or not the authentication information storage unit 10 stores the first authentication information by using the first authentication information acquired by the authentication information acquiring unit 20 as a search key. That is, the search unit 30 compares the first authentication information, and plural pieces of authentication information stored in the authentication information storage unit 10. A result of the comparison (result of the search) is transmitted to the following output unit 40.

The output unit 40 outputs the search result of the search unit 30. That is, in a case where the search result of the search unit 30 is “the authentication information storage unit 10 stores the first authentication information”, the output unit 40 outputs information indicating this effect through any output device such as a display, a speaker, and a printing device. In this manner, the user can recognize that the first electronic component is genuine. In addition, in this case, the output unit 40 may also output the stored attribute information correlated with the first authentication information.

On the other hand, in a case where the search result of the search unit 30 is “the authentication information storage unit 10 does not store the first authentication information”, the output unit 40 outputs information indicating this through the output device. In this manner, the user can recognize that the first electronic component is not genuine.

For performing an authentication of the electronic component by using a database in which authentication information acquired from an authentication pattern including a part or the entirety of a mottled pattern or a dot pattern formed on the electronic component is stored in advance as information for indentifying each of a plurality of electronic components, such an authentication device may be realized by installing a program on a computer, the program allowing the computer to perform a first authentication information acquiring step of acquiring a first authentication information from the authentication pattern formed on a first electronic component that is an object to be authenticated, a search step of searching whether or not the first authentication information is stored in the database, and an output step of outputting a search result of the search step.

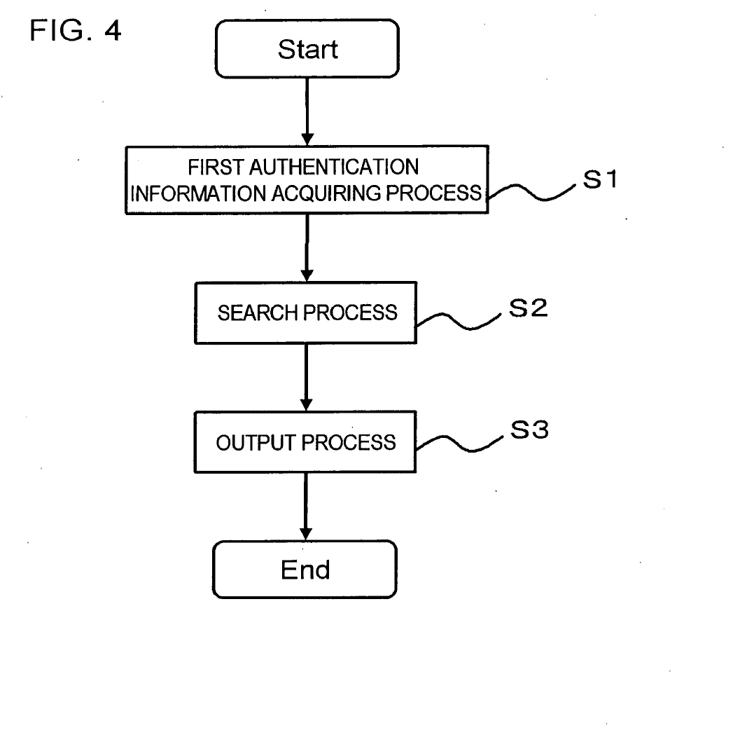

Next, an authentication method of this embodiment will be described. As shown in a flow chart of FIG. 4, the authentication method of this embodiment includes a first authentication information acquiring process S1, a search process S2, and an output process S3.

In the authentication method of this embodiment, authentication information acquired from an authentication pattern including a part or the entirety of a mottled pattern or a dot pattern formed on the electronic component is stored in the memory in advance as information for indentifying each of a plurality of electronic components. This configuration is realized by the above-described authentication information storage unit 10.

In the first authentication information acquiring process S1, first authentication information, which is acquired from an authentication pattern formed on the electronic component (the first electronic component) that is an object to be authenticated, is acquired. This process is realized by the above-described authentication-object authentication pattern acquiring unit 80.

In the search process S2, it is searched whether or not the first authentication information is stored in the memory (authentication information storage unit 10). This process is realized by the above-described search unit 30.

In the output process S3, the result of the search process S2 is output. This process is realized by the above-described output unit 40.

In addition, specifically, the authentication method of this embodiment may include processes described below.

First, information after encoding the authentication pattern formed on each electronic component according to a predetermined encoding rule is stored in the memory in advance as authentication information. This configuration is realized by the first unregistered authentication pattern acquiring unit 50, the first encoding unit 60, and the authentication information storage unit 10 described above.

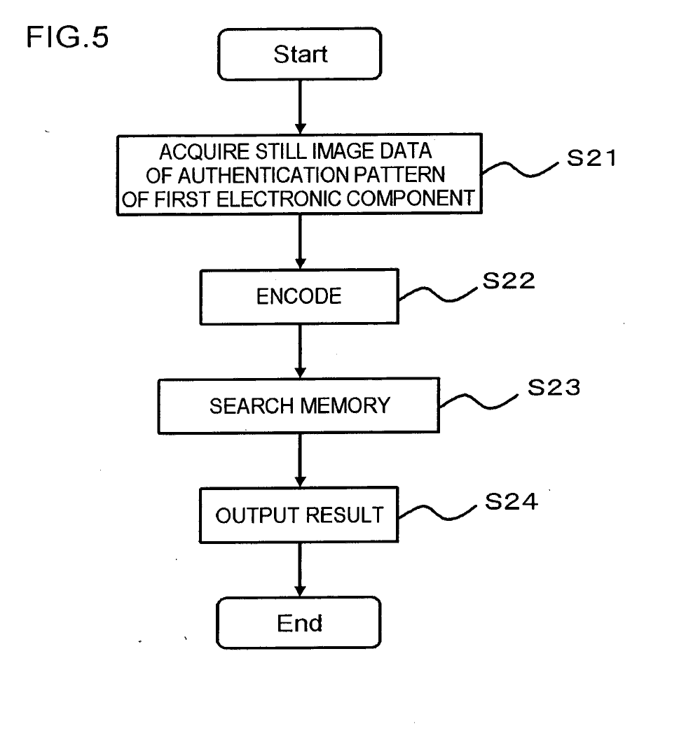

As shown in a flow chart of FIG. 5, still image data of the authentication pattern of the first electronic component is acquired (S21). This process is realized by the above-described authentication-object authentication pattern acquiring unit 80.

Then, the authentication pattern is encoded by using the still image data of the authentication pattern acquired in S21 (S22). This process is realized by the above-described second encoding unit 90.

Then, the memory (authentication information storage unit 10) is searched by using the information after being encoded in S22 as a search key, and whether or not the first authentication information is stored is confirmed (S23). This process is realized by the above-described search unit 30.

Then, the search result of S23 is output. This process is realized by the above-described output unit 40.

Next, applications of the authentication device 1 according to this embodiment will be described.

First Application

In the case of this application, the authentication device 1 shown in FIG. 3 is managed, for example, by a manufacturer of the electronic component or an authenticator of the electronic component. When receiving a request to authenticate any individual electronic component from a client, the manufacturer of the electronic component, or the authenticator of the electronic component acquires still image data of the authentication pattern formed on the electronic component from the client (reception via E-mail, reception of an input from a predetermined Web page, or the like). Then, the manufacturer of the electronic component or the authenticator of the electronic component inputs the acquired still image data to the authentication device 1. In this manner, the acquisition of the still image data by the authentication-object authentication pattern acquiring unit 80 is realized.

Subsequently, the encoding by the second encoding unit 90, the acquisition of the first authentication information (information after the encoding) by the authentication information acquiring unit 20, and the search by the search unit 30 are performed. Subsequently, a result of the authentication result is output by the output unit 40. From the output result, the manufacturer of the electronic component, or the authenticator of the electronic component can determine whether the electronic component that is requested is genuine. The manufacturer of the electronic component or the authenticator of the electronic component notifies the client of the result, and may supply the attribute information of the electronic component to the client as necessary, in a case where the electronic component is genuine.

In addition, the manufacturer of the electronic component or the authenticator of the electronic component may acquire the electronic component itself that is requested from the client, may image still image data of the authentication pattern formed on the electronic component, and may input the still image data to the authentication device 1.

Second Application

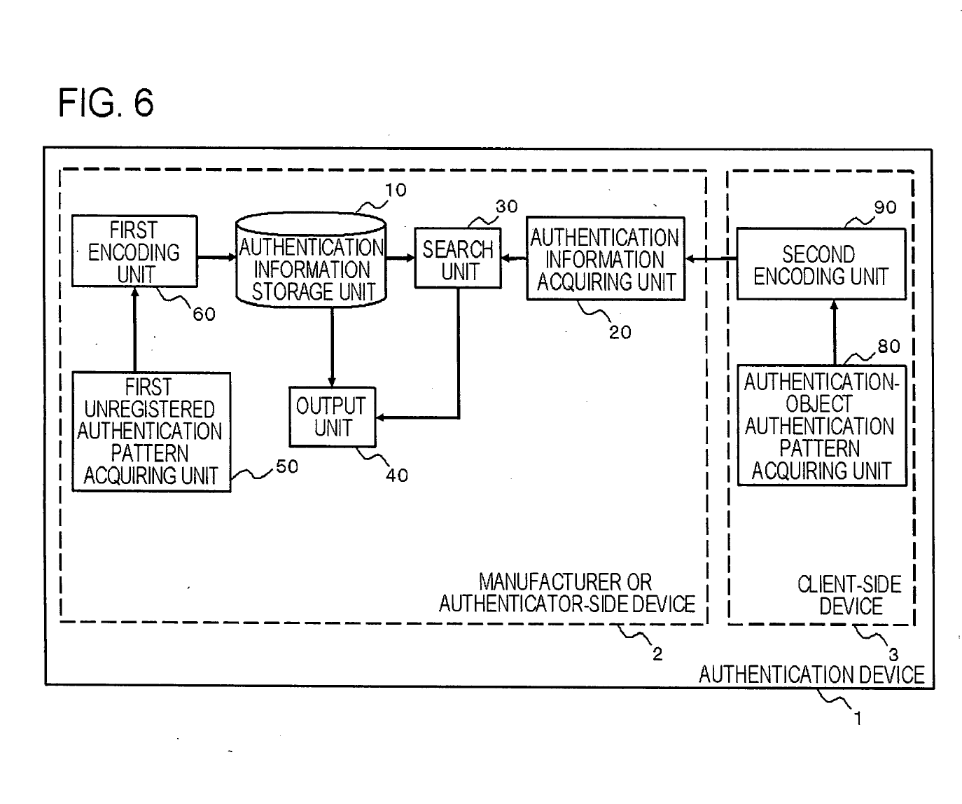

In the case of this application, as shown in FIG. 6, the authentication device 1 is divided into a manufacturer or authenticator-side device 2 managed by the manufacturer of the electronic component or the authenticator of the electronic component, and a client-side device 3. The client-side device 3 is provided to a client from the manufacturer or the authenticator.

The manufacturer or authenticator-side device 2 includes an authentication information storage unit 10, an authentication information acquiring unit 20, a search unit 30, an output unit 40, a first unregistered authentication pattern acquiring unit 50, and a first encoding unit 60. The client-side device 3 includes an authentication-object authentication pattern acquiring unit 80, and a second encoding unit 90. In addition, although it is not shown in the drawing, the manufacturer or authenticator-side device 2 may further include the authentication-object authentication pattern acquiring unit 80, and the second encoding unit 90.

In the case of this application, a client who desires to individually authenticate any electronic component images still image data of the authentication pattern formed on the electronic component that is to be authenticated, and then encodes the authentication pattern.

When receiving a request for the individual authentication of the electronic component from the client, the manufacturer of the electronic component or the authenticator of the electronic component also acquires the information after the encoding from the client (reception via E-mail, reception of an input from a predetermined Web page, or the like). In this manner, the acquisition of the first authentication information by the authentication information acquiring unit 20 of the manufacturer or authenticator-side device 2 is realized.

Next, the search by the search unit 30 is performed, and the result of the authentication is output by the output unit 40. From this output result, the manufacturer of the electronic component or the authenticator of the electronic component can determine whether the electronic component that is requested is genuine. The manufacturer of the electronic component or the authenticator of the electronic component notifies the client of the result and may supply the attribute information of the electronic component to the client as necessary.

In addition, in the case of this application, the encoding information for encoding the authentication pattern is supplied to the client. From the viewpoint of security, it is preferable that the encoding information be configured in a manner that is possible to be used only by the manufacturer of the electronic component or the authenticator of the electronic component. Therefore, the authentication device 1 may include a first authentication information storage unit that stores authentication information obtained by encoding the authentication pattern using the encoding information supplied to the client, and a second authentication information storage unit that stores authentication information obtained by encoding the authentication pattern using another encoding information. The latter encoding information is not supplied to the client, and is configured in a manner that is possible to be used only by the manufacturer of the electronic component or the authenticator of the electronic component. According to this configuration, it is possible to separately perform a comparison processing by using the encoding information possible to be used only by the manufacturer of the electronic component or the authenticator of the electronic component, in addition to the comparison processing by using the encoding information supplied to the client. Therefore, the security is enhanced.

Third Application

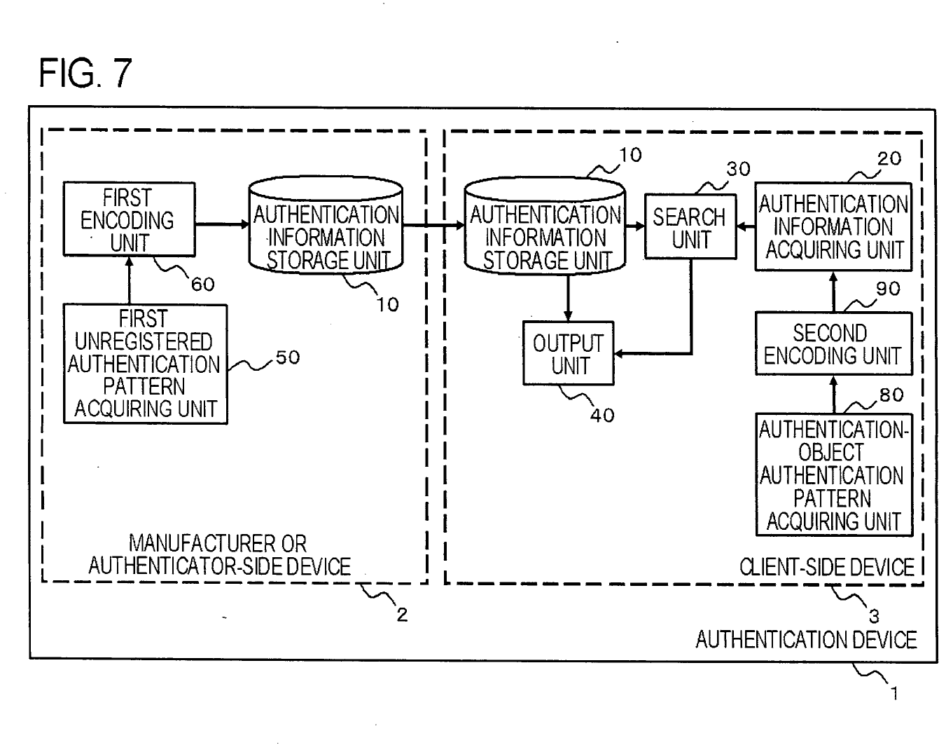

In the case of this application, as shown in FIG. 7, the authentication device 1 is divided into a manufacturer or authenticator-side device 2 managed by the manufacturer of the electronic component or the authenticator of the electronic component and a client-side device 3. The client-side device 3 is provided to a client from the manufacturer or the authenticator.

The manufacturer or authenticator-side device 2 includes an authentication information storage unit 10, a first unregistered authentication pattern acquiring unit 50, and a first encoding unit 60. The client-side device 3 includes an authentication information storage unit 10, an authentication information acquiring unit 20, a search unit 30, an output unit 40, an authentication-object authentication pattern acquiring unit 80, and a second encoding unit 90. The same authentication information is stored in the authentication information storage unit 10 included in the manufacturer or authenticator-side device 2, and in the authentication information storage unit 10 included in the client-side device 3. In addition, although it is not shown in the drawing, the manufacturer or authenticator-side device 2 may further include the authentication information acquiring unit 20, the search unit 30, the output unit 40, the authentication-object authentication pattern acquiring unit 80, and the second encoding unit 90.

In the case of this application, a client who desires to individually authenticate any electronic component images still image data of the authentication pattern formed on the electronic component that is to be authenticated, and then encodes the authentication pattern. Then, the information after the encoding is input to the client-side device 3. In this manner, the acquisition of the still image data by the authentication-object authentication pattern acquiring unit 80 is realized.

Next, the encoding by the second encoding unit 90, the acquisition of the first authentication information (information after the encoding) by the authentication information acquiring unit 20, and the search by the search unit 30 are performed. Then, a result of the authentication is output to the output unit 40. From this output result, the client can determine whether the electronic component that is requested is genuine. The client may output the attribute information of the electronic component and confirm it, as necessary.

In addition, in the case of this application, the encoding information for encoding the authentication pattern and the authentication information are supplied to the client. From the viewpoint of security, it is preferable that these pieces of encoding information be configured in a manner that is possible to be used only by the manufacturer of the electronic component or the authenticator of the electronic component. Therefore, the authentication device 1 may include a first authentication information storage unit that stores authentication information (authentication information supplied to the client) obtained by encoding the authentication pattern using the encoding information supplied to the client, and a second authentication information storage unit that stores authentication information obtained by encoding the authentication pattern using another encoding information. The another encoding information and the authentication information stored in the second authentication information storage unit are not supplied to the client, and are configured in a manner that is possible to be used only by the manufacturer of the electronic component or the authenticator of the electronic component. According to this configuration, it is possible to separately perform a comparison processing by using the encoding information and the authentication information possible to be used only by the manufacturer of the electronic component or the authenticator of the electronic component, in addition to the comparison processing by using the encoding information and the authentication information supplied to the client. Therefore, the security is enhanced.

According to such an authentication device of this embodiment, a user operation for an individual authentication of the electronic component includes only the imaging of the authentication pattern formed on the electronic component, and the input (or transmission to the manufacturer) of the imaged still image data. That is, it is not necessary to read out information including characters, numbers, or the like marked on the electronic component. As described above, according to the authentication device of this embodiment, it is possible to perform an individual authentication of the electronic component with sufficient accuracy without burdening a user with laborious work.

In addition, it is possible to reduce a data amount of the authentication information compared to a third embodiment (configuration where still image data of the authentication pattern is stored as the authentication information) described below. Therefore, it is possible to make the speed of the comparison processing fast while reducing a burden on the database.

Electronic Part

Next, an electronic component of this embodiment will be described.

### EXAMPLE 1

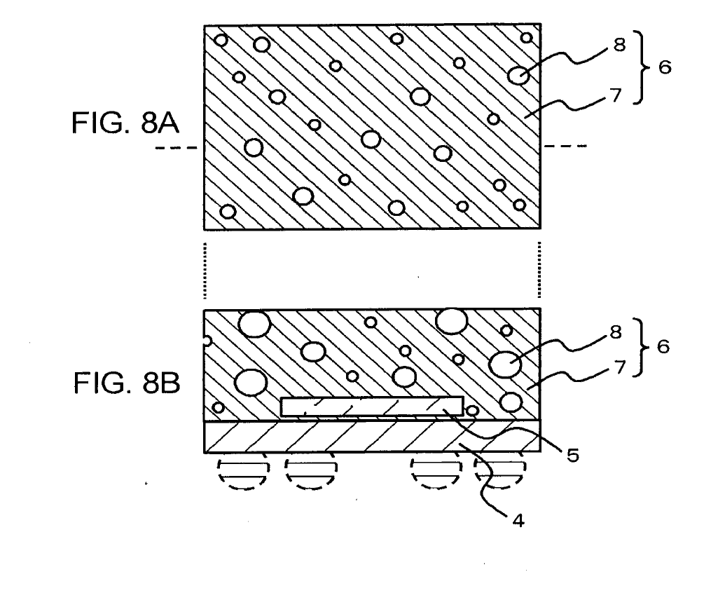

First, with reference to FIGS. 8A and 8B, an example of a configuration of the electronic component of this embodiment will be described. FIG. 8A represents a plan view schematically illustrating the electronic component of this embodiment, and FIG. 8B represents a cross-sectional view schematically illustrating the electronic component of this embodiment.

First, an outline of the electronic component of this embodiment will be described.

The electronic component of this embodiment may be a semiconductor device having a structure in which a semiconductor chip 5 mounted on a substrate 4 is sealed with a sealing material. In the example shown in FIGS. 8A and 8B, the semiconductor chip 5 is mounted on the substrate 4 in the form of a flip-chip; however, the semiconductor chip 5 may be mounted by using a bonding wire. A sealing section 6 formed by a sealing material includes a base section 7 that includes a resin, and a coloring particle 8 that is randomly dispersed in the inside of the base section 7. Hereinafter, the material making up the sealing section 6 of this embodiment is simply referred to as a “sealing material”. A dispersion state of the colored particle 8 is naturally formed when sealing the semiconductor chip 5, that is, when the sealing material in a molten state is injected on the substrate 4 at a predetermined location. The colored particle 8 has a color tone that can be identified in the base portion 7, and is formed with a dot pattern in regard to the top surface of the sealing portion 6 (see, FIG. 8A). In addition, although not shown in the drawings, the dot pattern may be formed on side surfaces of the sealing portion 6.

An electronic component of this embodiment has an authentication pattern on the exposed surfaces (sealing surfaces) in regard to the top surface and side surfaces of the sealing portion 6 formed of the sealing material. That is, the dot pattern formed on the exposed surfaces (sealing surfaces) in regard to the top surface and the side surfaces of the sealing portion 6 is used as the authentication pattern. In addition, all of the exposed surfaces may be used as the authentication pattern, or a part of the exposed surfaces (for example, only the top surface, only one of the side surfaces, or only a partial region in the top surface or the side surfaces) may be used as the authentication pattern.

Next, each elements making up the electronic component of this embodiment will be described.

The substrate 4 and the semiconductor chip 5 may be configured with any configuration and are not particularly restricted. Accordingly, the description thereof will not be repeated.

The base section 7 is a material that is generally used at the time of sealing the semiconductor chip (hereinafter, referred to as a “general sealing material”). For example, the base portion 7 may include (1) a base resin (epoxy resin, acryl resin, polyimide resin, other high molecular resin, or the like), (2) a filler (silica or the like), (3) coloring material (carbon black or the like), and (4) various additives (reaction speed controlling agent, ion trapping agent, a component for improving adhesiveness of a read frame and a chip, or the like). In addition, the base section 7 including the above-described items (1) to (4) is illustrative only, and may include other material. In addition, the base section 7 may not include any one of the items (1) to (4). In addition, the exemplification (in the brackets) of each of the material in the items (1) to (4) is illustrative only, and any material in the related art may be used. In addition, the sealing materials making up the sealing section 6 of this embodiment are different from the general sealing material according to whether or not the colored particle 8 described later is contained.

The colored particle 8 is randomly dispersed in the base section 7 and has a color tone that can be identified in the base section 7. That is, due to the colored particle 8 dispersed in the base section 7, the dot pattern is formed, and the dot pattern is used as the authentication pattern.

Here, it is preferable that the dot pattern formed by the colored particle 8, that is, the authentication pattern be formed in such a manner that the dispersion state of the colored particle 8 can be imaged by a camera, in consideration of the authentication processing. The imaging by the camera may be performed with the same magnification or with a predetermined magnification. However, it is preferable that the dot pattern be configured to be imaged by the camera with a relatively low magnification in consideration of general-purpose properties. From this viewpoint, it is preferable that a particle size of the colored particle 8 be 1 μm or more, and more preferably 10 μm or more. In regard to the presence or absence of a dot having a large contrast difference with the peripheral part, when the particle size is 10 μm or more, determination with the naked eye is possible, and therefore the restrictions or obstacles at the time of the authentication can be made significantly small. When a dedicated device is not necessary for the authentication, this has an effect of increasing a post-marketing authentication frequency, and therefore it is possible to greatly improve detection sensitivity when counterfeit goods are in circulation on the market. When the particle size is made to be relatively small, the dispersion state of the colored particle 8 is difficult to be identified as the dot pattern, and therefore it is necessary to image the dot pattern using a camera with a high magnification.

In addition, it is preferable that the particle size of the colored particle 8 be 100 μm or less, and more preferably 60 μm or less. A random dispersion state of the colored particle 8 is naturally formed at the time of sealing the semiconductor chip 5 with the sealing material; however, when the particle size of the colored particle 8 is larger than the above-described size, there is a problem in that the random dispersion state of the colored particle 8 cannot be obtained.

In addition, the particle size of each colored particle 8 may be substantially the same, or the colored particle 8 having a different particle size may be mixed. In a case where particles having a different particle size are mixed, the dot size of the dot pattern formed on the sealing surface (exposed surface) of the sealing section 6 varies, and as a result thereof, the variation of the dot pattern increases. That is, the number of variations in the authentication pattern increases, such that this configuration may be applied to an embodiment where the authentication pattern is formed on a plurality of electronic components.

In regard to the above-described particle size, when the size of a region where the authentication pattern is formed is 2 mm² or more, preferably 4 mm² or more, even in the case of a production volume of several millions, individual identification is possible. In addition, when the size of a region where the authentication pattern is formed is 400 mm² or less, it is possible to reduce load of an authentication-related process, and application to a small-sized part is possible.

Next, in regard to a region where the authentication pattern is formed, a ratio where the colored particle 8 (dot) is present (hereinafter, referred to as a “presence ratio”) is 0.05 particles/mm² or more, and preferably 0.5 particles/mm² or more. When it is too small relative to this ratio, the amount of information that can be acquired from the dot pattern becomes small, such that it is difficult to use this pattern as an authentication pattern for identifying a number of individuals. In addition, the information that can be acquired from the dot pattern is information for identifying each dot pattern (dot pattern formed on each electronic component), that is, the authentication information, and for example, the number of dots, a positional relationship of a plurality of dots (for example, information in which a plurality vectors are collected, each indicating a positional relationship of two dots), a size or a shape of each dot, which are observed, a color of the dot in a case where the colored particle 8 includes colored particles having a plurality of color tones, or the like may be considered. In addition, this exemplification is illustrative only, and the information acquired from the dot pattern for authentication (authentication pattern) is not limited thereto. In addition, the information that can be acquired from the dot pattern may be used as the input information in the above-described predetermined encoding rule.

On the other hand, in a case where the presence ratio is too larger, particularly, at the time of observing with a low magnification, it is difficult to recognize differences between individuals, such that 3 particles/mm² or less is preferable, and particularly, when the presence ratio is 1 particle/mm² or less, identification of the individuals can be performed with the naked eye at an accuracy of a constant value or more, such that this presence ratio is appropriate. In addition, in a case where the base resin includes a filler such as silica, even when an additive amount (weight ratio) of the colored particle in the base resin is smaller than that of the filler, it is possible to obtain the same effect of preventing the additive amount from being excessive. In addition, in a case where the contrast difference between the colored particle 8 and the color tone of the base resin is larger than the color tone of the silica and the base resin, even in the case of the resin including silica, it is possible to obtain high visibility that is hardly affected by the silica.

Here, as a configuration for controlling the presence ratio, for example, a configuration for adjusting the content of the colored particle 8 in the sealing material may be considered. As another configuration, a control configuration using a particle size distribution of the colored particle may be considered. It is considered that as the particle size becomes smaller or the ratio of the small particle size increases, the presence ratio increases. In addition, it is preferable that the presence ratio be within a constant difference in the same products from the viewpoint of difference in characteristics between individuals; however, a constant variation may be present in the presence ratio between regions in a single individual. For example, when the surface of the sealing section 6 is divided into a plurality of compartments, each having an area of 4 mm², if the difference in the presence ratio is 200% or more between the compartments in the single individual, it is possible to perform the identification using not only a position or a size of a colored point but also the number of the colored points, and at the time of the authentication, the search efficiency of the data is significantly improved.

Next, in regard to the sealing surface (exposed surface) of the sealing section 6, the ratio of the area occupied by the colored particle 8 (hereinafter, referred to as a “colored ratio”) is preferably 30% or less, more preferably 10% or less, and even more preferably 4% or less. When the area occupied by the colored particle 8 in the sealing surface is large, there is a concern in that variation of characteristics (for example, a heat absorbing characteristic at the time of heating using infrared ray, or the like) in the sealing surface, which is caused by the dispersion state of the colored particle 8, may occur locally.

Specifically, a region where the colored particle 8 is relatively close and a region where the colored particle 8 is hardly present occur, and therefore there is a concern in that a difference of characteristics (for example, a heat absorbing characteristic at the time of heating using infrared ray, or the like) between these regions may occur. Therefore, the colored ratio is preferably within the above-described value range. In addition, the colored ratio can be controlled by adjusting the particle size of the colored particle 8 and the presence ratio.

Next, the color tone of the colored particle 8 is not particularly restricted as long as the colored particle 8 can be identified in the base section 7, and any color tone may be selected according to the color tone of the base section 7. However, it is preferable to select a color tone such that the contrast difference between the color tone of the base section 7 and the color tone of the colored particle 8 becomes large. In this manner, the identification property of the colored particle 8 that is dispersed in the base section 7 is improved. For example, in a case where the base section 7 is black, the colored particle 8 may be a white color. In addition, it is preferable that a reflectance of visible light in the colored particle 8 be larger than the reflectance of visible light in the base section 7. According to this configuration, it is possible to recognize the colored particle 8 in the base section 7 with high accuracy. In a case where a stamping (lot number or the like) is made on the authentication pattern (exposed surface of the sealing section 6), the color tone of the colored particle 8 is preferably determined in consideration of a color of the stamping. In addition, the colored particle 8 may include two or more kinds of colored particle, each having different color tone.

The above-described colored particle 8 may be a particulate material including a resin (hereinafter, simply referred to as a “particulate material”). In addition, the colored particle 8 may be a pigment itself. The particulate material may include a color material or may not include such a material in a case where the resin has a desired color tone. In addition, the particulate material including the color material may be formed by kneading the resin and the color material, or may be formed by coating a part of or the entire surface of the particulate material, which is formed by using a resin or an inorganic material, with a layer including the color material. Here, the color material is not particularly restricted as long as it satisfies desired properties such as a desired color tone and a heat resistance that resists against a heating in a sealing process or the like, and it is possible to use any kind of color material such as pigment, and dye (including fluorescent dye).

In addition, the particulate material may include the same resin as the base resin included in the base section 7 (epoxy resin, acryl resin, polyimide resin, other high molecular resin, or the like). In this manner, the particulate material (colored particle 8) and the base section 7 are close to each other in regard to a specific weight thereof, and therefore the particulate material (the colored particle 8) easily disperses in the base section 7 at the time of the sealing processing. In addition, a shape of the particulate material may be a column shape such as a circular column and a fibrous form in addition to a spherical shape. In the case of a shape other than the spherical shape, a maximum diameter is called a particle size. In this manner, the shape of the dot formed on the sealing surface (exposed surface) of the sealing section 6 may be various shapes, and as a result thereof, the amount of information for authentication that can be acquired from the dot pattern increases.

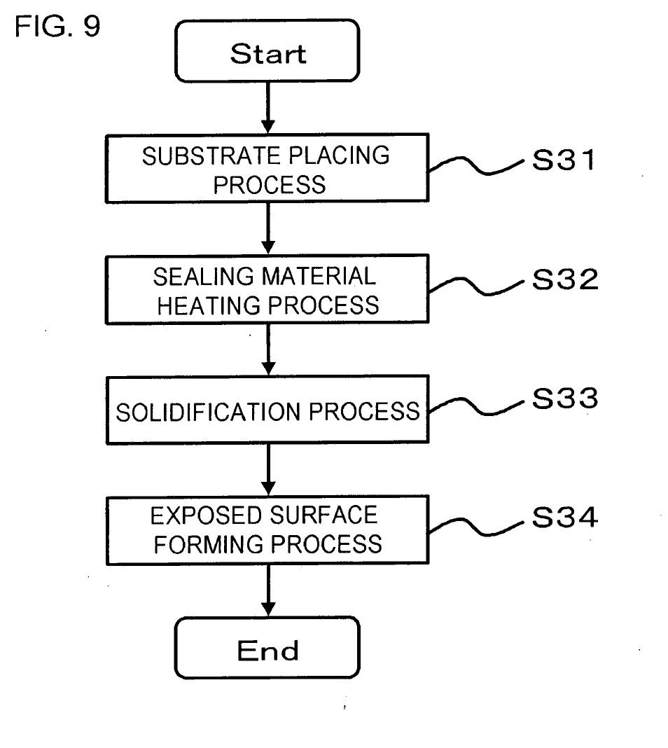

Next, an example of a method of manufacturing the electronic component of this embodiment will be described with reference to a flow chart of FIG. 9. In addition, the manufacturing method described here is illustrative only and the electronic component of this embodiment is not limited to that manufactured by the manufacturing method.

As shown in FIG. 9, the method of manufacturing the electronic component of this embodiment may include a substrate placing process S31, a sealing material heating process S32, and a solidification process S33. In addition, the method may further include an exposed surface forming process S34.

In the substrate placing process S31, the substrate 4 on which a plurality of semiconductor chips 5 are mounted is placed in a sealing mold. The process may be realized in compliance with the related art.

The sealing material heating process S32 is performed after the substrate placing process S31, and heats the sealing material including the sealing resin and the colored particle 8 injected in a pot. Here, a kind of the sealing resin is not particularly restricted; however, it is possible to use, for example, an epoxy resin or the like that are used a base resin of a general sealing material. The sealing material may include filler (silica or the like), a color material (carbon black or the like), and various additives (reaction speed controlling agent, ion trapping agent, a component for improving adhesiveness of a read frame and a chip, or the like).

In addition, the heating in the sealing material heating process S32 is performed in a condition where the sealing resin is molten and the colored particle 8 is not molten. This condition may be realized, for example, by an adjustment of the heating temperature or a design of the colored particle 8. As a design of the colored particle 8 satisfying the condition where the sealing resin is molten and the colored particle 8 is not molten, for example, a design where a material having a melting point higher than a sealing temperature (substantially 230° C.) is selected as the resin included in the colored particle 8, or a design where colored particle 8 is made to include thermosetting resin in which a hardening reaction is further progressed than that in the base resin even when the thermosetting resin and the base resin are the same kind as each other may be considered.

The solidification process S33 is performed after the sealing material heating process S32, and a molten material after the heating is injected in the sealing mold in which the substrate 4 on which the semiconductor chip 5 is mounted is placed and the molten material is solidified. In this manner, the semiconductor chip 5 is sealed, and a dot pattern is formed on the sealing surface (exposed surface) of the sealing section 6.

The exposed surface forming process S34 is performed after the solidification process S33 and an exposed surface of the solidified material (sealing section 6) formed by solidifying the molten material is removed, and thereby a second exposed surface made up by the solidified material (sealing section 6) is formed. A method for removing the exposed surface is not particularly restricted, and for example, a method such as polishing, cutting, blasting, etching or the like may be used. Through this process, the second exposed surface obtained by removing the exposed surface may be used as the authentication pattern. In this case, the existence probability of the colored particle 8 in the sealing surface (exposed surface) of the sealing section 6 becomes high, and a diameter of a planar shape and a shape of the colored particle 8 in the sealing surface (exposed surface) become varied. That is, when the existence probability of the colored particle 8 in the authentication pattern becomes high, the diameter of the planar shape and the shape of the colored particle 8 in the authentication pattern become varied. As a result thereof, it is possible to increase the information that can be acquired from the authentication pattern.

Then, the substrate 4 is divided to the semiconductor chip 5 unit.

Hereinafter, an example of a method of manufacturing the electronic component of this embodiment will be described in more detail.

First, a process of preparing the sealing material will be described.

As the colored particle 8, a particulate material obtained by kneading white-based pigment (for example, compounds such as oxide of TI, Sr, Zn, Pb, Cd, or the like) in an epoxy resin, and by subjecting the epoxy resin to a hardening reaction is prepared. The pigment is a compound such as an oxide and therefore it is relatively stable. In addition, the pigment is sealed in the resin, and therefore it has an insulating property and can suppress an ion migration or the like even in an electric field. The resin making up the particulate material is not limited to the epoxy resin; however, the resin may be, for example, a resin such as acryl and polyimide. In addition, the colored particle 8 may be formed by coating a surface of an inorganic material such as silica with a colored layer. The shape of the colored particle 8 is not particularly restricted; however, it may be a substantially spherical shape. In this manner, it is possible to secure flowability at the time of the sealing. For example, the colored particle 8 is hardened in air or liquid to have a spherical shape including different sizes and is sieved by a sieve having a predetermined mesh size, and thereby it is possible to obtain a shape with a desired size. The colored particle 8 having the spherical shape may be crushed to have various shapes.

Next, a sealing material (having a tablet shape) including the colored particle 8 in a desired volume ratio (for example, substantially 5%) is formed. The sealing material includes an epoxy-based sealing resin (epoxy component before the hardening reaction is completed) as a base resin, silica (SiO₂) filler, carbon black, other additives,' or the like, in addition to the colored particle 8. The formation of the sealing material (having a tablet shape) may be realized in compliance with the related art. For example, the formation of the sealing material is realized in such a manner that the material is kneaded, the kneaded material is made to be powder, and the powder is subject to a tablet compression (formed into a tablet shape). Even though a distribution of the colored particle 8 is biased due to a difference in a specific weight or a particle size at the time of the kneading, the kneaded material is made to be a powder (the colored particle 8 is fixed in each powder) and then the powder is subject to the tablet compression, such that the colored particle 8 is substantially uniformly distributed in the completed resin tablet from a macroscopic viewpoint.

Hereinafter, a process of sealing the semiconductor chip 5 using the sealing material will be described.

First, a plurality of semiconductor chips 5 are mounted on the substrate 4 (BGA substrate), and the substrate 4 and electrodes of the semiconductor chips 5 are connected though wires or the like, and then the substrate 4 on which the semiconductor chips 5 is mounted is placed in a sealing mold. Next, the tablet-shaped sealing material is injected in the resin pot of the sealing mold, and the sealing mold is heated, and thereby the resin component (base resin) becomes a molten material having a viscosity. Then, a pressure is applied to a pot, and therefore the molten material flows into a cavity formed by the mold on the semiconductor chips 5. The molten material has a constant viscosity, and the molten material is stirred by a flow at the time of flowing into the cavity, such that the colored particle 8 included in the molten material is distributed in a randomly dispersed state. Therefore, even in the case of the semiconductor chips 5 on the same substrate 4, the distribution of the colored particle 8 in the sealing material formed on the semiconductor chips 5 is different for each of the semiconductor chips 5 (for each individual chip). Then, a hardening reaction of the epoxy component in the base resin is progressed by performing a heat treatment, and therefore the sealing material is solidified. That is, the colored particle 8 is completely fixed.

At this time, a part of the colored particle 8 is fixed in a state where it comes into contact with the mold, and therefore after the electronic component is taken out from the mold, a part of the colored powder 8 is exposed from the surface of the sealing section 6 formed of the sealing material. In addition, the colored particle 8 is covered with the base resin layer with a small thickness. In these cases, a gap is made, such that the colored particle 8 may become visible.

In addition, it is not necessary to vary the sealing condition for each individual product, and even when the sealing work is continuously performed under the same conditions, it is possible to obtain a distribution of the colored particle 8 that is random for each individual, due to a small difference in the distribution of the colored particle 8 in the original tablet and the operation of a natural fluctuation such as a flow disturbance in the sealing mold. It is not necessary to manufacture each product under a different condition so as to apply a different identification information, and this is significantly advantageous in the field of manufacturing of the semiconductor device where the same products are massively manufactured.

After obtaining the electronic component of this embodiment in this manner, an authentication pattern that is a part of or the entirety of the exposed surface is imaged with a predetermined magnification. For example, the authentication pattern is imaged by an image acquiring unit including a camera or the like, which includes a CCD, CMOS sensor, and an optical system such as a lens. In addition, this imaging may be performed before the substrate is divided. In this case, the imaging may be performed for each semiconductor product region (region that is divided in a post-process), or a plurality of product regions (for example, for each substrate sheet) may be imaged at one time and then the acquired image data may be processed to divide the regions for each individual. According to the latter, positional information in the substrate is acquired at the same time, such that it is suitable for traceability.

Then, the acquired imaging data or a code generated from the data is stored in a server (authentication information storage unit 10) as authentication information of the electronic component. In addition, attribute information of the electronic component may be correlated with the authentication information and then may be stored in a server (authentication information storage unit 10).

In addition, the imaging of the authentication pattern and the storage in the server (authentication information storage unit 10) may be performed by the manufacturer of the electronic component as a part of the manufacturing process of the electronic component. In addition, the authenticator different from the manufacturer of the electronic component may acquire the electronic component on which the authentication pattern is formed, and may perform the imaging of the authentication pattern and the storage in the server.

Here, description will be given to an effect realized when the authentication device of this embodiment uses a part or the entirety of the dot pattern formed on the electronic component of this example as the authentication pattern.

(1) The electronic component of this example has a structure in which the semiconductor chip 5 mounted on the substrate 4 is sealed with the sealing material, and the dot pattern formed on the sealing surface (exposed surface) at the time of sealing the semiconductor chip 5 is used as the authentication pattern.

From this authentication pattern, it is possible to acquire information such as the dot state in the authentication pattern, that is, the number of dots, a positional relationship of a plurality of dots (for example, information in which a plurality of vectors is collected, each indicating a positional relationship of two dots), a color of the dot in a case where the colored particle 8 includes colored particles having a plurality of color tones, a shape of the dot in a case where the shape of the colored particle 8 is a columnar shape or the like, and it is possible to use one or more of these pieces of information as input information in regard to the predetermined encoding rule. This dot state is formed by a natural dispersion of the colored particle 8 in the base section 7 when the semiconductor chip 5 is sealed, such that the dot state may be different for each individual. Therefore, it is possible to use the dot pattern as an authentication pattern. In addition, it is difficult to artificially counterfeit such a dot state, and accordingly, it is excellent in regard to an anti-counterfeit aspect.

(2) In addition, the electronic component of this example may be configured in such a manner that the colored particle 8 dispersed in the base section 7 can be identified as the dot pattern at the time of imaging the authentication pattern with a camera under a predetermined imaging condition. In this case, a boundary of the base section 7 and the colored particle 8 is clear. In contrast, in the case of the electronic component having a mottled pattern described later, there is a concern in that the boundary specification of the mottled pattern is difficult. That is, it is easy to accurately identify the authentication pattern of the electronic component of this example. As a result thereof, authentication accuracy may be improved.

(3) In addition, in the case of the electronic component of the mottled pattern described below, there is a concern in that a difference in characteristics (for example, a heat absorbing characteristic at the time of heating using infrared ray, or the like) between individuals may occur due to the mottled pattern.

Specifically, there is a concern in that the heat absorbing characteristic becomes different between a region occupied by the first sealing section, a region occupied by the second sealing section, and a region where the first and second sealing section are mixed, due to a color tone difference between a first sealing section and a second sealing section making up the mottled pattern. In this case, there is a concern in that temperatures at the time of substrate mounting reflow vary between individuals in which the dispersion states in these regions are different, which may cause adhesion defects. In addition, even in the same product, there is a concern in that a difference in a warpage shape may occur due to a CTE difference and a distribution difference between the first and second sealing sections.

In contrast, according to the electronic component of this example, when a particle size of the colored particle 8 and a presence ratio are appropriately adjusted, it is possible to make small the occupancy of the colored particle 8 in the sealing surface (exposed surface) of the sealing section 6 while securing a state that can be used as the authentication pattern. In addition, the probability that the colored particle 8 will form a continuous region in the base section 7 is low, and the colored particle 8 forms a separate minute particle present independently in the base section 7. Therefore, variance in the position of the colored particle 8 in the base section 7 or a presence ratio in a predetermined region does not cause a significant difference in terms of the semiconductor device handling.

For example, even when the semiconductor device is heated in the substrate placing process, the heat absorption in the semiconductor device predominantly occurs in the base section 7 occupying the largest area, and in regard to a local effect by the colored particle 8, the region occupied by the colored particle 8 is small, and therefore the local effect is equalized in a short time by heat conduction. In addition, when considering the entirety of the sealing surface, a difference in the presence ratio of the colored particle between the individuals is small, such that the amount of heat absorption between the semiconductor device individuals becomes substantially the same.

(4) In addition, in the case of the electronic component having the mottled pattern described later, a plurality of resins having a different color formation is used, and flowing figures, which are naturally generated at the time of cavity injection, are used for the authentication, such that there is a concern in that a portion having reproducibility may be included in a formed pattern of the individuals for which the conditions at the time of the cavity injection are the same.

Even when a sealing mold in which a distance between a pot and a gate, and a location and a shape of the gate are different for each cavity is prepared, and then a totally different pattern is obtained with the same shot (injection unit of the sealing resin), there is a concern in that when comparing the same cavities in a subsequent shot, since the flow of the resin is not largely different, a pattern similar to that formed in a previous shot (a pattern having a commonality) is apt to be formed. In other words, there is a concern in that in regard to the formed authentication patterns, a fluctuation pattern and an artificially controllable pattern coexist.

Here, in the authentication information using the fluctuation (hereinafter, referred to as a “fluctuation ID”), there is a risk that the same ID will be accidentally formed unlike an ID such as two-dimensional bar code that is artificially applied (hereinafter, referred to as an “artificial ID”). Therefore, when using the pattern having reproducibility in the case of the electronic component of the mottled pattern, the risk becomes large.

In addition, when the acquisition of the pattern is performed in a relatively strict fashion and the amount of information of the ID is increased to make the risk small, particularly, this leads to a non-negligible load increase in the authentication system of the electronic component in which an enormous amount of identification is necessary.

In addition, the individual authentication information (hereinafter, referred to as an “ID”), which is obtained from the pattern having the reproducibility, includes information that is unnecessary for the individual authentication, this also increases the load in the authentication system. For example, in a case where three points of characteristic points are picked up for a pattern matching from the acquired pattern, and one point thereof is a common point in a specific population (individual in which the same cavity is manufactured), this point cannot be used in an actual authentication. Nonetheless, when information of the one point is included in the ID information, this deteriorates the authentication accuracy, or increases the size of each data by increasing the identifiable characteristic points to be acquired.

In contrast, according to the electronic component of this example, the authentication pattern is formed by a particle (colored particle), such that it is difficult to artificially control the position or the size of each colored particle in the authentication pattern and accordingly there is no reproducibility in the distribution thereof.

In a case where the region formed by a plurality of particles that are dense like the flowing figures is used as an authentication unit, the reproducibility may be included due to a tablet disposition in the resin pot similar to the related art, or a shape of the mold; however, the distribution of each particle in the authentication region is not easily affected by the tablet disposition and the shape of the mold and in practice it is impossible to control the distribution, such that it is possible to exclude the portion having the reproducibility from the authentication pattern.

(5) In addition, it is preferable that the infrared absorption ratio of the colored particle 8 be smaller than that in the base section 7. According to this configuration, in the case of IR heating, it is possible to suppress an effect caused by the distribution of the colored particle 8.

(6) In addition, the authentication pattern may be formed by removing a surface layer, that is, by removing a part or the entirety of the sealing surface (exposed surface) after the sealing (after the base resin is cured) through polishing, cutting, blasting, etching, lasering, or the like. In the unchanged sealing state, the colored particle 8 is exposed only at a contact point between the colored particle 8 and the mold; however, when the sealing surface (exposed surface) after the sealing is removed at least by the thickness of substantially one tenth of the largest particle size of the colored particle 8, preferably substantially one fifth, it is possible to increase the probability that the colored particle 8 will be exposed from the sealing surface. In the case of using this configuration, even when the content of the colored particle 8 in the sealing material is reduced, it is possible to obtain an authentication pattern having sufficient information for identification. The upper limit of the removal depth is not restricted as long as the depth is within a range where the colored particle 8 is dispersed; however, when the sealing surface is removed more than necessary, a change in the warpage behavior or the like occurs, such that the upper limit of the removal depth is set to 100 times or less of the largest particle size of the colored particle 8, and preferably 10 times or less.

(7) In addition, in a case where the authentication pattern is obtained through the polishing of the sealing surface (exposed surface) or the like after the sealing, the diameter and the shape of a cross-sectional shape of the colored particle on the exposed surface become varied, and as a result thereof it is possible to increase the authentication information.

(8) In addition, in a case where the authentication pattern is obtained through the polishing of the sealing surface (exposed surface) after the sealing, an exposed curvature radius R of the colored particle 8 becomes larger than a non-exposed curvature radius R of the colored particle 8. When the flatness of the authentication pattern of the surface exposing portion increases, it is possible to obtain a high authentication accuracy.

(9) In addition, the electronic component of this example may have a stamping made on the sealing surface (exposed surface). The authentication may be performed with the stamping region masked or with the stamping region included. In addition, it is possible to use the stamping as information (specifying information) for specifying the authentication pattern in the still image data. The electronic component of this example has a characteristic in that visibility of the stamping region is excellent in a case where the stamping is made on a surface of the semiconductor device.

(10) In addition, this example is not limited to an aspect where the dot pattern is formed on the sealing surface of a Ball Grid Array (BGA) and is used for the authentication pattern. The dot pattern may be formed on the sealing surface of a Quad Flat Package (QFP) or the like and may be used as the authentication pattern. In addition, an object on which the dot pattern is formed may be a solder resist layer of an interconnection substrate or a protective layer on a surface of the chip. As long as the pattern is formed using a natural fluctuation, it is possible to form a near-infinite number of identification information even with the same manufacturing formula, and a specific process is not necessary.

(11) In addition, in this example, the authentication pattern (dot pattern) is formed on the exposed surface of the electronic component, such that a processing property for an optical recognition is excellent. In addition, the authentication pattern is formed at an easily visible position, such that when counterfeiting is performed, it is easy to detect the counterfeiting.

(12) In addition, in this example, the dot pattern, which is formed at a part serving a predetermined function (for example, the sealing section serving a function of sealing the semiconductor chip) in the electronic component, is used as the authentication pattern, such that it is difficult to destroy the authentication pattern without causing the function of the electronic component to be lost. That is, when the authentication pattern is destroyed, there is a possibility that a part of the function of the electronic component is lost. Accordingly, it is expected that the acts destroying the authentication pattern will be suppressed and that the security property will be improved. Particularly, in a case where the resin making up the authentication pattern directly comes into contact with the functional part such as a chip and an interconnection, or the resin making up the authentication pattern interposes the functional part in two or more directions, it is difficult to destroy or substitute the authentication pattern while maintaining the function of the functional part.

(13) In addition, it is possible to construct traceability consistent from semiconductor assembly to shipping, or traceability information including combined information of each constituent member by combining identification information of a chip, a substrate, a sealing resin, or the like.

(14) In addition, the dot pattern formed on the sealing surface is used as the authentication pattern, such that the authentication pattern is formed simply by changing the material in the sealing process, and therefore the cost is reduced, and an increase in the number of processes is suppressed to the minimum.

(15) In addition, it is difficult for the authenticator to discriminate a controllable reproduced pattern and a pattern formed by natural fluctuation. In a case where the characteristic portions of an irregular shape are similar to each other, there is a risk in that even when the pattern is a reproduced pattern, the pattern may be determined as the pattern formed by natural fluctuation. This is the same in the case of the system. Therefore, in a case where a similar pattern (for example, between the same cavities) and a pattern not having the reproducibility (between different cavities) are mixed, if a difference between the former and the latter is used as a reference, even when the formers are separate patterns, there is a high risk in that they are determined as the same patterns. In addition, if a difference between the former and the former is used as a reference, the authentication efficiency is decreased. In the case of a particle distribution, a variation in the magnitude of a difference between individuals is small, and it is possible to minimize this type of false recognition risk as well as the decrease in efficiency.

(16) Particularly, it is preferable that the resin layer include the colored particle having a particle size equal to or more than 10 μm and equal to or less than 100 μm, and an additive amount of the colored particle 8 or the like be adjusted in such a manner that a region where the dot pattern including the colored particle 8 is observed in a density equal to or more than 0.05 particles/mm² and equal to or less than 3 particles/mm² is formed in the authentication surface of the resin layer.

Even in a case where an area of a region that is an object to be authenticated is suppressed to be relatively small, when the particle size of the colored particle 8 and the dot pattern generated according to this particle size become small, it is possible to sufficiently secure the number of variations of generated random patterns, on the other hand, it is preferable that an observation resolution (number of pixels) be equal to or less than a given value from the viewpoints of an authentication load and an amount of data and it is not preferable that an area for one pixel be extremely small. At this time, when the density of the dot pattern is high, a probability that a plurality of dot patterns will be included in one pixel becomes high, and an analog determination according to the number of included dot patterns is required, which causes a decrease in the authentication accuracy. Therefore, in regard to the particle size of the colored particle 8, the additive amount of the colored particle 8 or the like is adjusted in such a manner that a region where the dot pattern including the colored particle 8 is observed in a density equal to or more than 0.05 particles/mm² and equal to or less than 3 particles/mm² is formed in the authentication surface of the resin layer, such that the diversity of the patterns (number of variations of a random pattern) and the authentication accuracy can be suitably compatible with each other.

### EXAMPLE 2

Hereinafter, another example of the electronic component of this embodiment will be described.

The electronic component of this example is different from the electronic component of the example 1 in that unevenness is formed in the exposed surface of the sealing section 6.

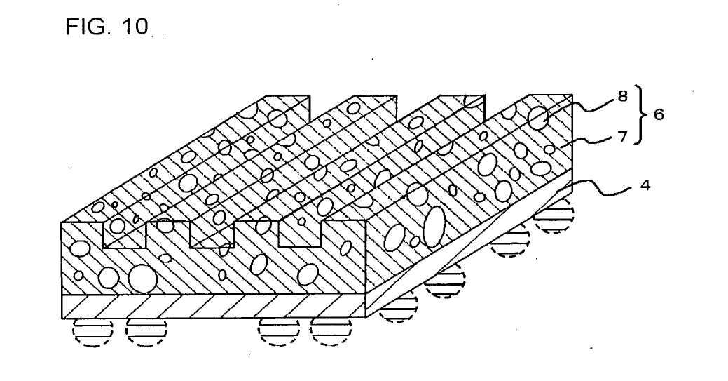

FIG. 10 represents a diagram schematically illustrating an example of the electronic component of this example. In the electronic component shown in the drawing, the unevenness is formed by drawing parallel lines at a predetermined pitch. According to this configuration, the number of dot patterns that can be used as the authentication pattern is increased and the counterfeiting becomes more difficult, in addition to the effect realized by using a part or the entirety of the dot pattern formed on the electronic component described in the example 1 as the authentication pattern.

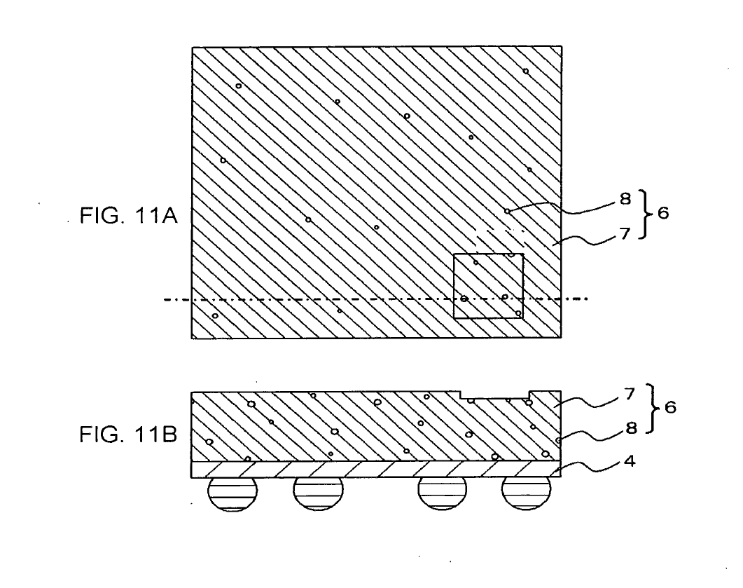

FIGS. 11A and 11B represent another example of the electronic component of this example. FIG. 11A represents a plan view schematically illustrating an example of the electronic component of this example, and FIG. 11B represents a cross-sectional view schematically illustrating an example of the electronic component of this example. The example shown in FIGS. 11A and 11B is different from the example shown in FIG. 10 in the shape of the unevenness.

In addition, the unevenness shown in FIG. 10 and FIGS. 11A and 11B is an example, and the unevenness of the electronic component of this example may have another shape.

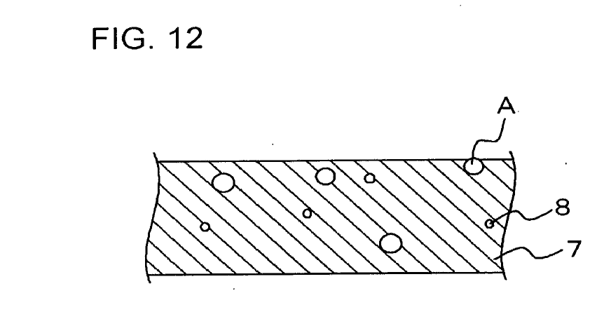

Here, description will be given to a configuration for forming the unevenness and a configuration of the unevenness formed using each configuration with reference to FIGS. 12 to 15. FIGS. 12 to 15 represent cross-sectional views schematically illustrating a part of an example of the electronic component according to this embodiment.

FIG. 12 represents a diagram illustrating a shape of the electronic component before forming the concave portion. In addition, the colored particle 8 indicated by a symbol A shows the colored particle 8 observed when a surface of the electronic component in a state shown in the drawing is observed (observed from the upper side to the lower side in the drawing).

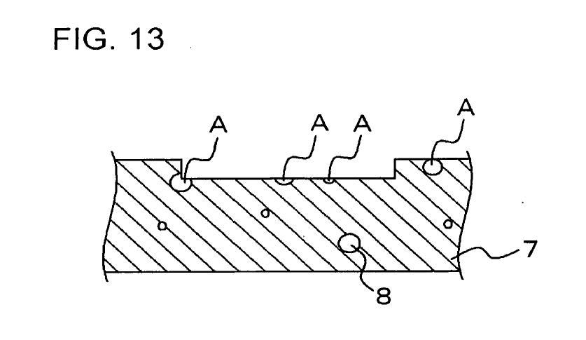

FIG. 13 represents a diagram illustrating a shape of the electronic component, in which the concave portion is formed in the electronic component of a state shown in FIG. 12 by using a mechanical forming method electronic component shown in FIG. 13, the colored particle 8 that is not observed in a state of FIG. 12 can be observed. That is, when the concave portion is formed, the number of dots making up the dot pattern on the surface of the electronic component increases.

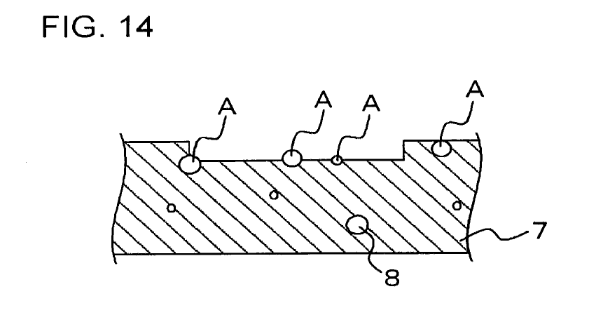

FIG. 14 represents a diagram illustrating a shape of the electronic component, in which the concave portion is formed in the electronic component of a state shown in FIG. 12 by using a method such as dry etching, wet etching, and blasting. In the case of this method, a condition where the selectivity of the colored particle 8 becomes low is selected, such that as shown in FIG. 14, the concave portion is formed in such a manner that the colored particle 8 remains as a protrusion in the concave portion. In regard to the electronic component shown in FIG. 14, the colored particle 8 that is not observed in a state of FIG. 12 can be observed. That is, when the concave portion is formed, the number of dots making up the dot pattern on the surface of the electronic component increases.

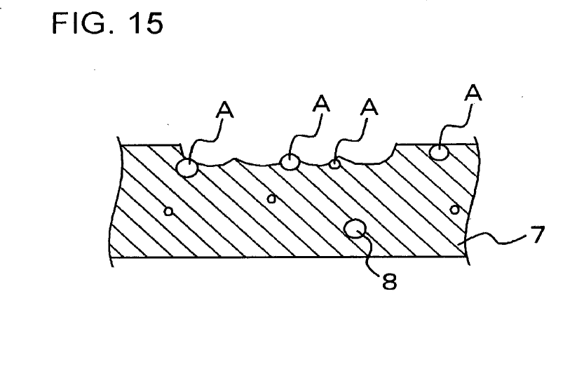

FIG. 15 represents a diagram illustrating the electronic component, in which the concave portion is formed in the electronic component of a state shown in FIG. 12 by scanning in parallel using a laser beam. In addition, FIG. 15 represents a cross-sectional view orthogonal to the scanning direction. A laser irradiation area is relatively small, such that the laser irradiation may be performed plural times to form a desired concave portion. In addition, in the case of this method, the selectivity is adjusted, and thereby as shown in FIG. 15, the concave portion can be formed in such a manner that the colored particle 8 remains as a protrusion in the concave portion. In addition, it is possible to adjust the depth of the concave portion by changing the scanning speed and the times. In regard to the electronic component shown in FIG. 15, the colored particle 8 that is not observed in a state of FIG. 12 can be observed. That is, when the concave portion is formed, the number of dots making up the dot pattern on the surface of the electronic component increases.

In the case of the electronic component shown in FIGS. 13 to 15, when an angle of observing the shape of the dot pattern, for example, an angle for imaging the dot pattern is changed, it is possible to obtain a different imaging information (authentication pattern), and it is suitable for a usage in which a high authentication property and a high counterfeiting barrier are required.

In addition, a transparent resin may be buried in the concave portion. In this manner, it is possible to secure the authentication pattern due to the transparent resin buried in the concave portion. In addition, the transparent resin buried in the concave portion may be formed in a predetermined convex shape, and may allow it to function as a lens for observing the authentication pattern. In this case, the visibility of the authentication pattern is improved, such that it preferable.

### EXAMPLE 3

Hereinafter, another example of the electronic component according to this embodiment will be described.

In the electronic component of the example 1, the authentication pattern (dot pattern) is formed by using a part of an existing constituent element such as the sealing section 6 formed of a sealing material for sealing the semiconductor chip 5, which is included in the electronic component, but, the electronic component of this example is different from the example 1 in that the authentication pattern (dot pattern) is applied at an arbitrary position of the electronic component.

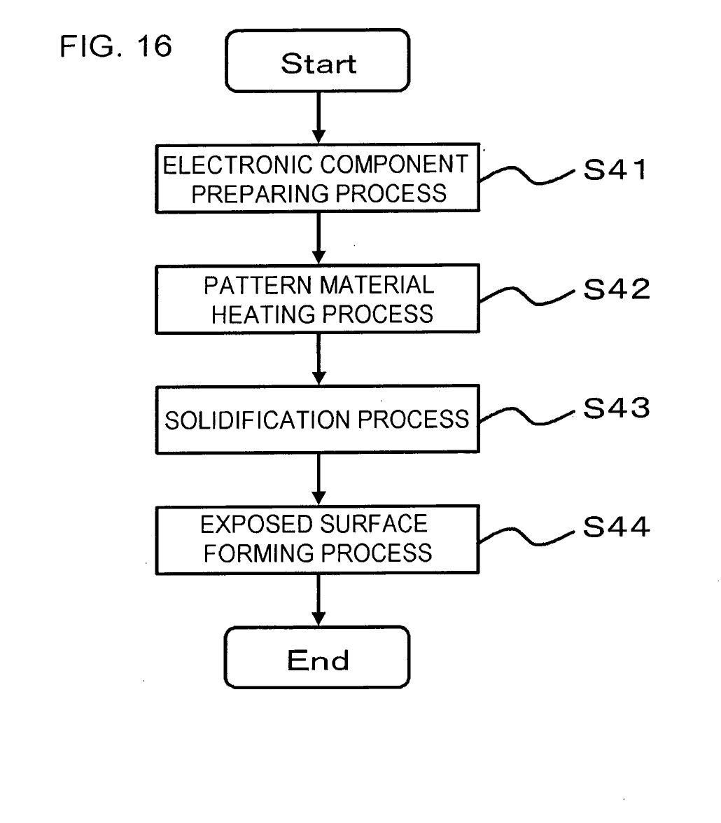

First, a method of manufacturing the electronic component of this example will be described with reference to a flow chart in FIG. 16.

As shown in FIG. 16, the method of manufacturing the electronic component of this example may include an electronic component preparing process S41, a pattern material heating process S42, and a solidification process S43. Further, the method may further include an exposed surface forming process S44.

In the electronic component preparing process S41, the electronic component is prepared. The kind of the electronic component is not particularly restricted, and any electronic component may correspond thereto.

In the pattern material heating process S42, a pattern material including a base resin serving as a base of the authentication pattern and a colored particle 8 is heated. The colored particle 8 has the same configuration as that described in the example 1. The colored particle 8 has a color tone that can be identified in the pattern material. In addition, the pattern material may have the same configuration as the sealing material described, for example, in the example 1. The heating in the pattern material heating process S42 is performed under a condition where the base resin is molten and the colored particle 8 is not molten. In regard to this condition, the same condition as that described in regard to the sealing material heating process S32 of the example 1 may be used.

The solidification process S43 is performed after the pattern material heating process S42, the molten material after the heating is made to flow onto the electronic component and then is solidified. For example, a predetermined amount of molten material is made to flow onto a predetermined position on the electronic component using a dispensing nozzle or the like and then is solidified. In addition, the position on the electronic component to which the molten material flows is a design matter.

The exposed surface forming process S44 is performed after the solidification process S43 and an exposed surface of the solidified material formed by solidifying the molten material is removed, and thereby a second exposed surface made up by the solidified material is formed. The exposed surface forming process S44 is similar to the exposed surface forming process S34 described in the example 1, such that description thereof will not be repeated.

In addition, after the exposed surface forming process S44, a process of selectively removing the second exposed surface to form unevenness on the second exposed surface may be further included. This process may be realized by a unit that scans a predetermined position of the second exposed surface with a laser beam, or the like. The process may be performed after the solidification process S43. In this case, it is preferable that the exposed surface forming process S44 not be performed.

According to the method of manufacturing the electronic component according to this example, it is possible to apply the authentication pattern (dot pattern) having an operation effect described in the example 1 to any electronic component.

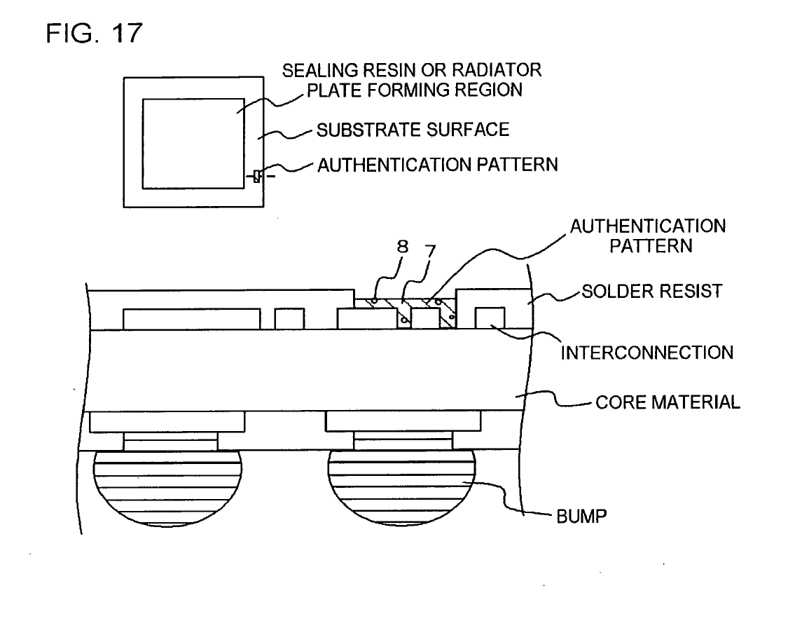

Here, a specific example of the electronic component of this example will be described for reference using FIGS. 17 to 19.

FIG. 17 illustrates an electronic component in which a part of SR of the substrate is opened, pattern material is made to flow through this opening, and thereby the authentication pattern is formed. In FIG. 17, a drawing shown in an upper side is a schematic plan view, and a drawing shown in a lower side is a schematic cross-sectional view taken along a dotted line in the schematic plan view. This opening is formed in a substrate manufacturing process. In addition, a timing when a pattern material is made to flow is not particularly restricted, and the inflow of the pattern material may be performed in a so-called substrate manufacturing process or a semiconductor manufacturing process. In addition, the pattern is formed before mounting a chip, such that the pattern can be used for associating individual substrates and chips with each other.

A method of flowing the pattern material is not particularly restricted; however, for example, a supply from a nozzle, a printing, a scanning after the printing, or the like may be used. In addition, the required characteristics of the pattern material are extremely relaxed compared to the required characteristics of the sealing material, such that a thermoplastic resin, or a base resin except for a black one may be used. In addition, a configuration where interconnection in FIG. 17 is not formed may be possible. In the case of the configuration shown in FIG. 17, a structure formed of a pattern material serves as an interconnection protective layer, such that a tamper property (in which the function is also destroyed at the time of tampering) is improved. In addition, a base resin having a mechanical strength higher than that of a solder resist is used, such that there is an effect in that in the case of removing the authentication resin, the SR layer is broken at the same time.

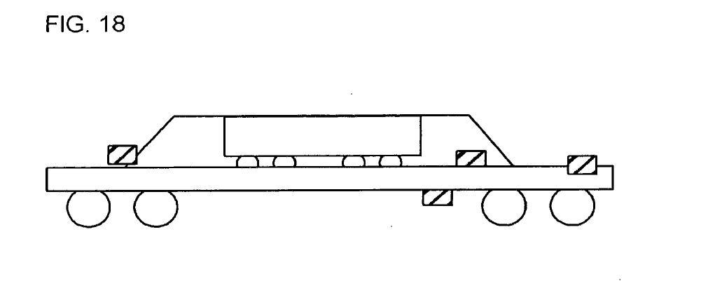

FIG. 18 represents a diagram schematically illustrating a Flip Chip Ball Grid Array (FCBGA). According to this example, the molten material is made to flow to an arbitrary position of the FCBGA, for example, a position (on the substrate, a radiator plate shape or the like) indicated by a diagonal line hatching in FIG. 18 and then is solidified therein in the solidification process S43, and thereby it is possible to form an authentication pattern (dot pattern).

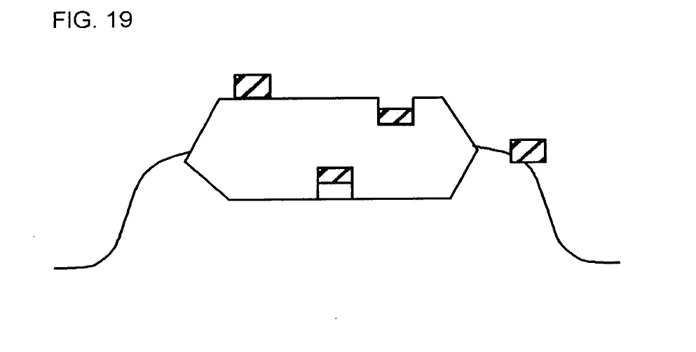

In addition, as shown in FIG. 19, the molten material may be made to flow onto the sealing section that seals the semiconductor chip, or onto a lead and then may be solidified in the solidification process S43, and thereby may form the authentication pattern (dot pattern). In addition, as shown in FIG. 13, a concave portion may be formed at a predetermined position on the electronic component (in FIG. 13, the exposed surface of the sealing section), and the molten material may be made to flow to the inside of the concave portion and may be solidified in the solidification process S43, and thereby the authentication pattern (dot pattern) may be formed. In this manner, a region making up the authentication pattern becomes clear. In addition, a preservation stability of the authentication pattern is improved. That is, in a case where the molten material is made to flow onto a flat surface of the electronic component and is solidified, and thereby the authentication pattern is formed, the solidified material makes up a convex portion, and therefore a peeling-off or the like may occur; however, in a case where the authentication pattern is formed inside of the concave portion, this problem does not easily occur.

### EXAMPLE 4

Hereinafter, another example of the electronic component according to this embodiment will be described.

The authentication pattern may be obtained by a method capable of obtaining a random particle distribution through a natural fluctuation. In addition, the authentication pattern may be a dot pattern formed on an electronic component by dropping the colored particle 8 on a surface of the sealing resin before the hardening or on the mold that is brought into contact with a surface of the sealing resin, and then by flowing sealing material into the mold and solidifying the sealing material. In this case, the colored particle is distributed on the surface with a high density, such that it is possible to make the variation of characteristics of the entirety of the electronic component minimum.

### EXAMPLE 5

Hereinafter, another example of the electronic component according to this embodiment will be described.

The electronic component of this example has a mottled pattern. A method of manufacturing such an electronic component may be realized by a technique described in Japanese Laid-Open Patent Publication No. 2007-242973.

Here, description will be given with respect to an effect realized when the authentication device of this embodiment uses a part or the entirety of a mottled pattern formed on the electronic component of this example as the authentication pattern.

(1) The electronic component of this example has a structure in which the semiconductor chip 5 mounted on the substrate 4 is sealed with the sealing material, and the mottled pattern formed on the sealing surface (exposed surface) at the time of sealing the semiconductor chip 5 is used as the authentication pattern.

From this authentication pattern, it is possible to acquire information such as a mottled state in the authentication pattern, that is, coordinate information of a boundary portion (a boundary portion of the mottled pattern) of a color on an outer frame of the authentication pattern, an area occupancy of each color, a color at the central position of the authentication pattern, or the like, and it is possible to use one or more of these pieces of information as input information in regard to the predetermined encoding rule. This mottled state is formed by a natural dispersion of the molten sealing material when the semiconductor chip 5 is sealed, such that the mottled pattern may be different for each individual at a constant probability. Therefore, it is possible to use the mottled pattern as an authentication pattern. In addition, it is difficult to artificially counterfeit such a mottled pattern, and accordingly, it is excellent in regard to an anti-counterfeiting aspect.

(2) In addition, it is possible to construct traceability information consistent from the semiconductor assembly to shipping, or traceability information including combined information of each constituent member by combining identification information of a chip, a substrate, a sealing resin, or the like.

(3) In addition, the mottled pattern formed on the sealing surface is used as the authentication pattern, and therefore the cost is reduced, and an increase in the number of processes is suppressed to the minimum.

(4) In addition, it is difficult for the authenticator to discriminate a controllable reproduced pattern and a pattern formed by natural fluctuation. In a case where the characteristic portions of an irregular shape are similar to each other, there is a risk in that even when the pattern is a reproduced pattern, the pattern may be determined as the pattern formed by natural fluctuation. This is also the same in the case of the system. Therefore, in a case where a similar pattern (for example, between the same cavities) and a pattern not having the reproducibility (between different cavities) are mixed, if a difference between the former and the latter is made as a reference, even when the formers are separate patterns, there is a high risk that they will be determined as the same patterns. In addition, if a difference between the former and the former is made as a reference, the authentication efficiency is decreased. In the case of a particle distribution, a variation in the magnitude of a difference between individuals is small, and it is possible to minimize this type of false recognition risk as well as the decrease in the efficiency.

### Second Embodiment

Authentication Device 1

Authentication device 1 of this embodiment is configured based on the configuration of the authentication device 1 of the first embodiment except that an overlap confirming unit 70 is further included.

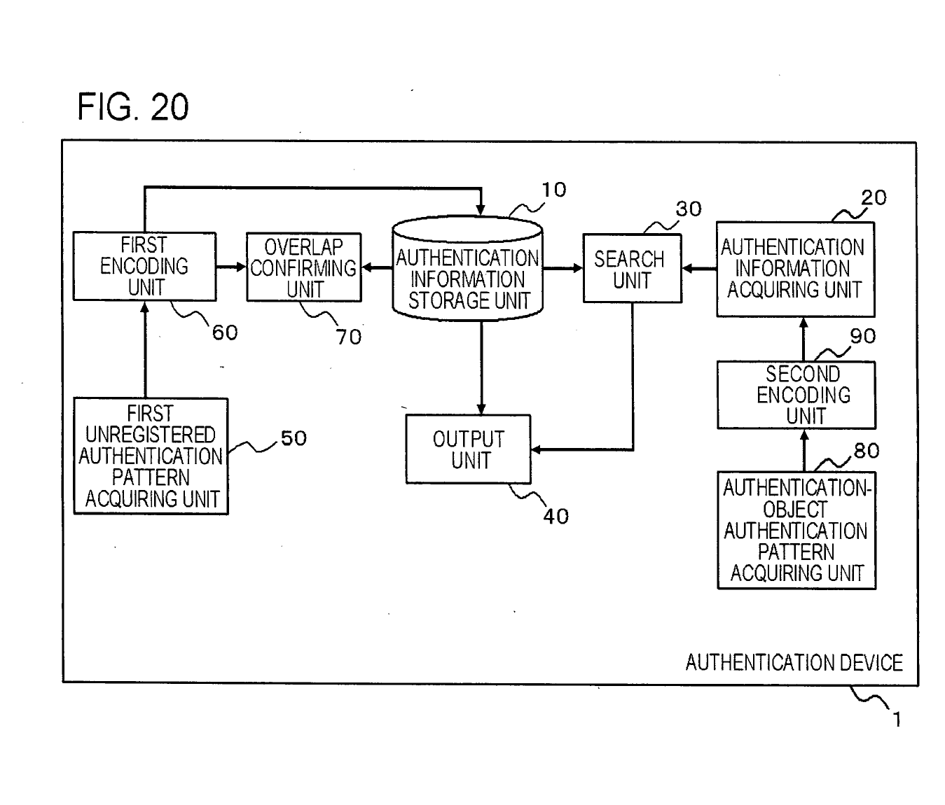

As shown in FIG. 20, the authentication device 1 of this embodiment includes an authentication information storage unit 10, an authentication information acquiring unit 20, a search unit 30, an output unit 40, a first unregistered authentication pattern acquiring unit 50, a first encoding unit 60, and an overlap confirming unit 70. In addition, the authentication device 1 may further include an authentication-object authentication pattern acquiring unit 80 and a second encoding unit 90. Hereinafter, configurations of the overlap confirming unit 70, the authentication information storage unit 10, the first unregistered authentication pattern acquiring unit 50, and the first encoding unit 60 will be described. In addition, configurations of other units are substantially the same as those in the first embodiment, and therefore description thereof will not be repeated. In addition, applications of the authentication device 1 of this embodiment are substantially the same as those in the first embodiment, and therefore description thereof will not be repeated. In addition, the configuration of the electronic component of this embodiment is substantially the same as that in the first embodiment, and therefore description thereof will not be repeated.

The overlap confirming unit 70 confirms whether or not the information after encoding the authentication pattern formed on the second electronic component is already stored in the authentication information storage unit 10. That is, the overlap confirming unit 70 confirms whether or not the information after the encoding by the first encoding unit 60 is already stored in the authentication information storage unit 10. Specifically, when acquiring the information after the encoding by the first encoding unit 60, the overlap confirming unit 70 compares this information and plural pieces of authentication information stored in the authentication information storage unit 10.

In addition, this confirmation process by the overlap confirming unit 70 is performed before the information after the encoding by the first encoding unit 60 is stored in the authentication information storage unit 10. Then, in a case where the confirmation result of the overlap confirming unit 70 is “not stored”, the authentication information storage unit 10 of this embodiment stores the information after the encoding as the authentication information. On the other hand, in a case where the confirmation result of the overlap confirming unit 70 is “stored”, the authentication information storage unit 10 of this embodiment does not store the information after the encoding. In this case, the first unregistered authentication pattern acquiring unit 50 and the first encoding unit 60 perform the following processes.

The first unregistered authentication pattern acquiring unit 50 of this embodiment acquires still image data of the authentication pattern made up by a part of the mottled pattern or the dot pattern formed on the second electronic component. In a case where the confirmation result of the overlap confirming unit 70 is “stored”, the first unregistered authentication pattern acquiring unit 50 acquires still image data of the authentication pattern made up by another part of the mottled pattern or the dot pattern formed on the second electronic component.

For example, the first unregistered authentication pattern acquiring unit 50 divides the mottled pattern or the dot pattern having a predetermined size, which is formed on the second electronic component, into a plurality of area (for example, nine areas) (see FIGS. 1 and 2), and acquires a mottled pattern or dot pattern in one area (for example, a left-upper area) as an authentication pattern. In a case where the information after encoding this authentication pattern is already stored in the authentication information storage unit 10, the first unregistered authentication pattern acquiring unit 50 acquires a mottled pattern or a dot pattern in another area (for example, an upper-center area) determined according to a predetermined rule as the authentication pattern. The authentication pattern acquired by the first unregistered authentication pattern acquiring unit 50 may be any pattern as long as it is different from the pattern previously acquired, and a configuration of determining the authentication pattern is not limited to the above-described configuration.

The first encoding unit 60 of this embodiment encodes the authentication pattern according to a predetermined encoding rule by using still image data of the authentication pattern acquired by the first unregistered authentication pattern acquiring unit 50. The overlap confirming unit 70 confirms whether or not the information after the encoding by the first encoding unit 60 is already stored in the authentication information storage unit 10.

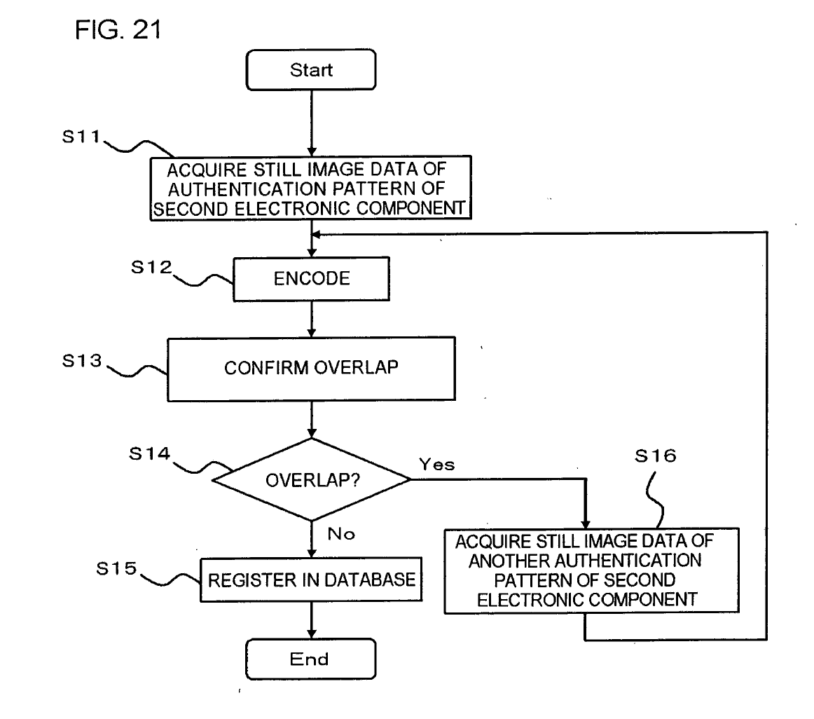

Next, a processing flow for storing the recognition information by the authentication device 1 of this embodiment will be described by using a flow chart of FIG. 21.

First, the authentication device 1 acquires the still image data of the authentication pattern of the second electronic device (S11). This process is realized by the first unregistered authentication pattern acquiring unit 50.

Next, the authentication pattern from which the still image data is acquired in S11 is encoded (S12). This process is realized by the first encoding unit 60.

Next, it is confirmed whether or not the information after encoding in S12 is already stored in the authentication information storage unit 10 (S13). This process is realized by the overlap confirming unit 70.

In a case where the information is already stored in the authentication information storage unit 10 (Yes in S14), still image data of another authentication pattern of the second electronic component is acquired (S16). This process is realized by the first unregistered authentication pattern acquiring unit 50. Then, the process is returned to S12, and the above-described processes are repeated.

On the other hand, in a case where the information is not stored in the authentication information storage unit 10 (No in S14), the authentication information storage unit 10 stores the information after encoding in S12 as the authentication information (S15).

Here, an operational effect of the authentication device of this embodiment will be described.

In a case where an application is made to the electronic component described in the first embodiment, that is, in a case where the mottled pattern or the dot pattern formed using a natural flow is used as the authentication pattern, it is difficult to completely exclude the probability that the information after encoding the authentication pattern will overlap. According to the authentication device of this embodiment, it is possible to avoid such a disadvantage.

### Third Embodiment

An authentication device 1 of this embodiment is configured based on a partial configuration of the authentication device 1 according to the first embodiment, except that the authentication information storage unit 10 stores still image data obtained by imaging the authentication pattern including the mottled pattern or the dot pattern as the authentication information.

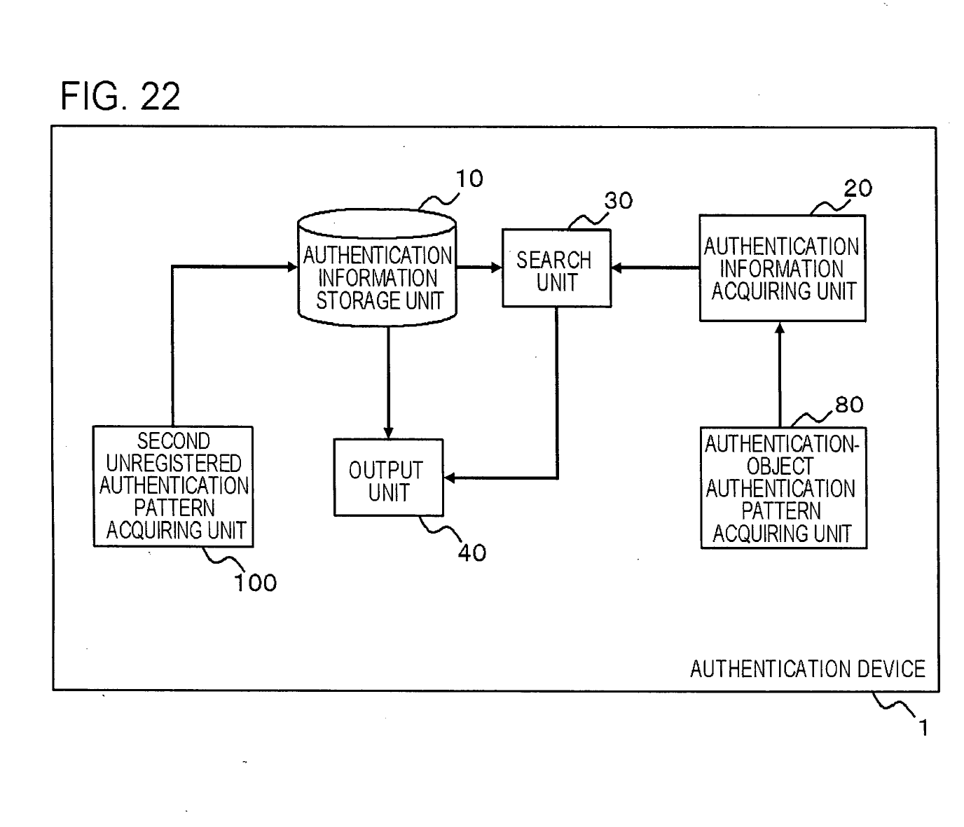

As shown in FIG. 22, the authentication device 1 of this embodiment includes an authentication information storage unit 10, an authentication information acquiring unit 20, a search unit 30, an output unit 40, an authentication-object authentication pattern acquiring unit 80, and a second unregistered authentication pattern acquiring unit 100. Hereinafter, configurations of the authentication information storage unit 10, the authentication information acquiring unit 20, the search unit 30, and the second unregistered authentication pattern acquiring unit 100 will be described. In addition, configurations of other units are substantially the same as those in the first embodiment, and therefore description thereof will not be repeated. In addition, applications of the authentication device 1 of this embodiment are substantially the same as those in the first embodiment, and therefore description thereof will not be repeated. In addition, the configuration of the electronic component of this embodiment is substantially the same as that in the first embodiment, and therefore description thereof will not be repeated.

The second unregistered authentication pattern acquiring unit 100 is configured to acquire still image data of the authentication pattern formed on the second electronic component. In addition, a timing for imaging the authentication pattern formed on the second electronic component is not particularly limited, but may be a timing described below. For example, as one process among processes for manufacturing the electronic component, a process of imaging the authentication pattern formed on the second electronic component is included, and the imaging of the pattern may be performed at this timing. The imaging at the timing may be performed, for example, by a manufacturer of the electronic component. In addition, the authentication pattern formed on the second electronic component may be imaged at a timing not included during the process of manufacturing the electronic component. The imaging at the timing may be performed, for example, by the manufacturer of the electronic component, or an authenticator (a person who works for the authentication of the electronic component) different from the manufacturer of the electronic component.

The authentication information storage unit 10 of this embodiment stores still image data of the authentication pattern acquired by the second unregistered authentication pattern acquiring unit 100 as the authentication information.

The authentication information acquiring unit 20 of this embodiment acquires still image data of an authentication pattern acquired by the authentication-object authentication pattern acquiring unit 80 as a first authentication information.

The search unit 30 of this embodiment searches whether or not the authentication information storage unit 10 stores the first authentication information by using the first authentication information (still image data of the authentication pattern) acquired by the authentication information acquiring unit 20 as a search key. That is, the search unit 30 compares the first authentication information and plural pieces of authentication information stored in the authentication information storage unit 10 using an existing pattern matching or the like. A result of the comparison (result of the search) is transmitted to the output unit 40.

According to such an authentication device of this embodiment, a user operation for an individual authentication of the electronic component includes only the imaging of the authentication pattern formed on the electronic component, and the input (or transmission to the manufacturer) of the imaged still image data. That is, it is not necessary to read out information including characters, numbers, or the like marked on the electronic component. As described above, according to the authentication device of this embodiment, it is possible to perform an individual authentication of the electronic component with sufficient accuracy without burdening a user with laborious work.

### Fourth Embodiment

An authentication device 1 of this embodiment is configured based on a partial configuration of the authentication device 1 according to the third embodiment, except that the authentication information storage unit 10 stores information that can be acquired from the authentication pattern including the mottled pattern or the dot pattern as the authentication information.

As the information that can be acquired from the authentication pattern, for example, the number of dots in a case where the authentication pattern is a dot pattern, the number of dots for each color in a case where dots of a plurality of colors are present, a positional relationship of a plurality of dots (for example, information in which a plurality vectors are collected, each indicating a positional relationship of two dots), or the like may be considered. In addition, in a case where the authentication pattern is a mottled pattern, coordinate information of a boundary portion (a boundary portion of the mottled pattern) of a color on an outer frame of the authentication pattern, an area occupancy of each color, a color at the central position of the authentication pattern, or the like may be considered. In addition, the above-described exemplification is illustrative only, the information that can be acquired from the authentication pattern may include another information, or may include one or more of the exemplifications.

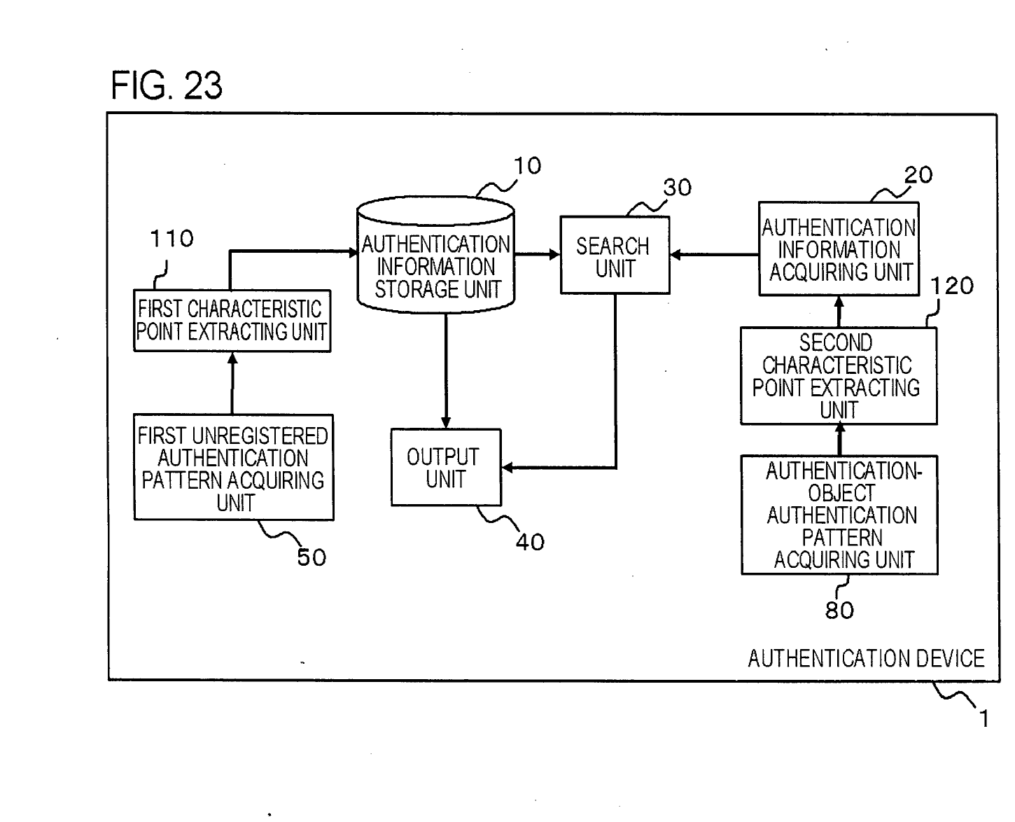

As shown in FIG. 23, the authentication device 1 of this embodiment includes an authentication information storage unit 10, an authentication information acquiring unit 20, a search unit 30, an output unit 40, a first unregistered authentication pattern acquiring unit 50, an authentication-object authentication pattern acquiring unit 80, a first characteristic point extracting unit 110, and a second characteristic point extracting unit 120. Hereinafter, a configuration of the authentication information storage unit 10, the authentication information acquiring unit 20, the search unit 30, the first characteristic point extracting unit 110, and the second characteristic point extracting unit 120 will be described. In addition, configurations of other units are substantially the same as those in the first embodiment, and therefore description thereof will not be repeated. In addition, applications of the authentication device 1 of this embodiment are substantially the same as those in the first embodiment, and therefore description thereof will not be repeated. In addition, the configuration of the electronic component of this embodiment is substantially the same as that in the first embodiment, and therefore description thereof will not be repeated.

When acquiring still image data of an authentication pattern formed on the second electronic component from the first unregistered authentication pattern acquiring unit 50, the first characteristic point extracting unit 110 extracts one or more characteristic points from the authentication pattern. The characteristic point that is extracted is not particularly restricted; however, for example, the number of dots in a case where the authentication pattern is a dot pattern, the number of dots for each color in a case where dots of a plurality of colors are present, a positional relationship of a plurality of dots (for example, information in which a plurality vectors are collected, each indicating a positional relationship of two dots), or the like may be considered. In addition, in a case where the authentication pattern is a mottled pattern, coordinate information of a boundary portion (a boundary portion of the mottled pattern) of a color on an outer frame of the authentication pattern, an area occupancy of each color, a color at the central position of the authentication pattern, or the like may be considered. In addition, the above-described exemplification is illustrative only, the information that can be acquired from the authentication pattern may include another information, or may include one or more of the exemplifications.

The authentication information storage unit 10 of this embodiment stores one or more characteristic points extracted by the first characteristic point extracting unit 110 as the authentication information.

When still image data of an authentication pattern formed on the first electronic component is acquired from the authentication-object authentication pattern acquiring unit 80, the second characteristic point extracting unit 120 extracts one or more characteristic points from the authentication pattern. The characteristic point extracted herein is the same as the characteristic point extracted by the first characteristic point extracting unit 110.

The authentication information acquiring unit 20 of this embodiment acquires the characteristic point extracted by the second characteristic point extracting unit 120 as a first authentication information.

The search unit 30 of this embodiment searches whether or not the authentication information storage unit 10 stores the first authentication information by using the first authentication information (characteristic point) acquired by the authentication information acquiring unit 20 as a search key. A result of the comparison (result of the search) is transmitted to the output unit 40.

According to such an authentication device of this embodiment, a user operation for an individual authentication of the electronic component includes only the imaging of the authentication pattern formed on the electronic component, and the input (or transmission to the manufacturer) of the imaged still image data. That is, it is not necessary to read out information including characters, numbers, or the like marked on the electronic component. As described above, according to the authentication device of this embodiment, it is possible to perform an individual authentication of the electronic component with sufficient accuracy without burdening a user with laborious work.

In addition, it is possible to reduce a data amount of the authentication information compared to the third embodiment (configuration where still image data of the authentication pattern is stored as the authentication information) described below. Therefore, it is possible to make the speed of the comparison processing fast while reducing a burden on the database.

It is apparent that the present invention is not limited to the above embodiment, and may be modified and changed without departing from the scope and spirit of the invention.

What is claimed is:

1. An authentication device, comprising:
an authentication information storage unit that stores authentication information acquired from an authentication pattern including a part or the entirety of a mottled pattern or a dot pattern formed over an electronic component as information for indentifying each of a plurality of electronic components;
an authentication information acquiring unit that acquires a first authentication information acquired from the authentication pattern formed over a first electronic component that is an object to be authenticated;
a search unit that searches whether or not the authentication information storage unit stores the first authentication information by using the first authentication information as a search key; and
an output unit that outputs a search result of the search unit.

2. The authentication device according to claim 1, wherein the authentication information storage unit stores each attribute information of the electronic component by correlating the attribute information with the authentication information, and
in a case where the authentication information storage unit stores the first authentication information, the output unit outputs the attribute information, which is correlated with the first authentication information, as the search result.

3. The authentication device according to claim 1, further comprising:
a first unregistered authentication pattern acquiring unit that acquires still image data of the authentication pattern formed over a second electronic component whose authentication information is not stored in the authentication information storage unit; and
a first encoding unit that encodes the authentication pattern according to a predetermined encoding rule by using the still image data acquired by the first unregistered authentication pattern acquiring unit,
wherein the authentication information storage unit stores information after the encoding as the authentication information.

4. The authentication device according to claim 3, further comprising:
an overlap confirming unit that confirms whether the authentication information storage unit already stored the information after encoding the authentication pattern formed over the second electronic component,
wherein in a case where the confirmation result by the overlap confirming unit is “not-stored”, the authentication information storage unit stores the information after the encoding as the authentication information.

5. The authentication device according to claim 4,
wherein the first unregistered authentication pattern acquiring unit acquires the still image data of the authentication pattern including a part of the mottled pattern or the dot pattern formed over the second electronic component, and acquires again the still image data of the authentication pattern including another part of the mottled pattern or the dot pattern formed over the second electronic component in a case where the confirmation result by the overlap confirming unit is “stored”, and
the first encoding unit encodes the authentication pattern according to the encoding rule by using the still image data that is acquired again by the first unregistered authentication pattern acquiring unit.

6. The authentication device according to claim 3, further comprising:
an authentication-object authentication pattern acquiring unit that acquires the still image data of the authentication pattern of the first electronic component; and
a second encoding unit that encodes the authentication pattern according to the encoding rule by using the still image data acquired by the authentication-object authentication pattern acquiring unit,
wherein the authentication information acquiring unit acquires information after being encoded by the second encoding unit as the first authentication information.

7. The authentication device according to claim 1, further comprising:
a second unregistered authentication pattern acquiring unit that acquires still image data of the authentication pattern formed over the second electronic component whose authentication information is not stored in the authentication information storage unit,
wherein the authentication information storage unit stores the still image data acquired by the second unregistered authentication pattern acquiring unit as the authentication information.

8. The authentication device according to claim 7, further comprising:
an authentication-object authentication pattern acquiring unit that acquires still image data of the authentication pattern of the first electronic component,
wherein the authentication information acquiring unit acquires the still image data acquired by the authentication-object authentication pattern acquiring unit as the first authentication information.

9. The authentication device according to claim 1,
The mottled pattern and the dot pattern are formed in such a manner that a molten material including a coloring material and a resin in a molten state is supplied over the electronic component, and then the molten material is solidified.

10. An authentication method, in which authentication information acquired from an authentication pattern including a part or the entirety of a mottled pattern or a dot pattern formed over an electronic component is stored in a memory in advance as information for indentifying each of a plurality of electronic components, the method comprising:
acquiring a first authentication information from the authentication pattern formed over a first electronic component that is an object to be authenticated;
searching whether or not the first authentication information is stored in the memory; and
outputting a search result of the step of searching.

11. An information storage medium storing a program for performing an authentication of an electronic component by using a database in which authentication information acquired from an authentication pattern including a part or the entirety of a mottled pattern or a dot pattern formed over the electronic component is stored in advance as information for indentifying each of a plurality of electronic components, the program allowing a computer to perform:
acquiring a first authentication information from the authentication pattern formed over a first electronic component that is an object to be authenticated;
searching whether or not the first authentication information is stored in the database; and
outputting a search result of the step of searching.
